(19) United States
(12) Patent Application Publication
(10) Pub. No.: US 2026/0239050 A1
(43) Pub. Date: Aug. 13, 2026

(54) METHODS, DEVICES AND MEDIUM FOR COMMUNICATION

(71) Applicant: NEC Corporation, Tokyo (JP)

(72) Inventors: Zhen HE, Beijing (CN); Peng GUAN, Beijing (CN); Rao SHI, Beijing (CN); Gang WANG, Beijing (CN)

(73) Assignee: NEC Corporation, Tokyo (JP)

(21) Appl. No.: 19/156,062

(22) PCT Filed: Feb. 14, 2023
(86) PCT No.: PCT/CN2023/075909

§ 371 Date: Aug. 13, 2025

(51) Int. Cl. H04W 24/08; H04B 7/06

(52) U.S. Cl. CPC H04W 24/08; H04B 7/06952

(57) ABSTRACT

Embodiments of the present disclosure provide a solution on reporting model performances. A terminal device determines a first set of parameters based on a first measurement on a first set of reference signals and a second set of parameters based on a second measurement on a second set of reference signals and a data processing model. The terminal device determines first information based on a comparison between the first and second sets of parameters. The terminal device determines second information based on the first information and predetermined condition information and transmits the second information to the network device. The second information indicates at least one of: status information related to a performance metric, a number related to the performance metric, or a percentage related to the performance metric. In this way, the terminal device knows how to report the performance metric of the AI/ML model.

### FIELDS

Example embodiments of the present disclosure generally relate to the field of communication techniques and in particular, to methods, devices, and medium for reporting model performance.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. Thus, solutions on sufficiently reporting AI/ML performance are needed.

### SUMMARY

In general, embodiments of the present disclosure provide methods, devices and computer storage medium for reporting model performance.

In a first aspect, there is provided a terminal device. The terminal device comprises a processor, configured to cause the terminal device to: determine, based on a first measurement on a first set of reference signals, a first set of parameters; determine, based on a data processing model and a second measurement on a second set of reference signals, a second set of parameters; determine first information based on a comparison between the first set of parameters and the second set of parameters; determine second information based on predetermined condition information and the first information, wherein the second information indicates at least one of: status information related to a performance metric, a number related to the performance metric, a percentage related to the performance metric, or the first information; and transmit the second information to the network device.

In a second aspect, there is provided a network device. The network device comprises a processor, configured to cause the network device to: receive, from a terminal device, second information indicating indicates at least one of: status information related to a performance metric, a number related to the performance metric, a percentage related to the performance metric, or the first information, wherein the second information is determined based on predetermined condition information and first information, wherein the first information is determined based on a comparison between a first set of parameters and a second set of parameters, and wherein the first set of parameters is determined based on a first measurement on a first set of reference signals, and the second set of parameters is determined based on and a second measurement on a second set of reference signals.

In a third aspect, there is provided a method for communication. The method comprises determining, based on a first measurement on a first set of reference signals, a first set of parameters; determining, based on a data processing model and a second measurement on a second set of reference signals, a second set of parameters; determining first information based on a comparison between the first set of parameters and the second set of parameters; determining second information based on predetermined condition information and the first information, wherein the second information indicates at least one of: status information related to a performance metric, a number related to the performance metric, a percentage related to the performance metric, or the first information; and transmitting the second information to the network device.

In a fourth aspect, there is provided a method for communication. The method comprises receiving, from a terminal device, second information indicating indicates at least one of: status information related to a performance metric, a number related to the performance metric, a percentage related to the performance metric, or the first information, wherein the second information is determined based on predetermined condition information and first information, wherein the first information is determined based on a comparison between a first set of parameters and a second set of parameters, and wherein the first set of parameters is determined based on a first measurement on a first set of reference signals, and the second set of parameters is determined based on and a second measurement on a second set of reference signals.

In a fifth aspect, there is provided a computer readable medium having instructions stored thereon, the instructions, when executed on at least one processor, causing the at least one processor to carry out the method according to the third, or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of reporting angle information in accordance with some embodiments of the present disclosure;

FIG. 3 illustrates a flowchart of a method implemented at a terminal device according to some example embodiments of the present disclosure;

FIG. 4 illustrates a flowchart of a method implemented at a network device according to some example embodiments of the present disclosure; and

FIG. 5 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1 (e.g., 550 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is.

As mentioned above, AI/ML models are applied in different scenarios. For UE-side performance monitoring, i.e., model monitoring is performed at UE side, UE needs to monitor (i.e., calculate or measure) the performance metric (or monitoring results) corresponding to the AI/ML model and report it to network (NW). Specifically, for beam management (BM) case (i.e., spatial/temporal beam prediction using one-sided model), UE may need to monitor and report the following performance metrics to NW: beam prediction accuracy, or L1-reference signal received power (RSRP) difference. For CSI compression using two-sided model or temporal CSI prediction with one-sided model, UE may need to monitor and report the following performance metrics to NW: squared generalized cosine similarity (SGCS) or normalized mean squared error (NMSE). However, how to report the above performance metrics (especially the intermediate key performance indicators (KPIs)) corresponding to the AI/ML model has not been discussed so far. It means that, there is no effective and reasonable method for reporting the performance metric corresponding the AI/ML model.

In order to solve at least part of the above problems, embodiments of the present disclosure provide a solution on reporting model performances. A terminal device determines a first set of parameters based on a first measurement on a first set of reference signals and a second set of parameters based on a second measurement on a second set of reference signals and a data processing model. The terminal device determines first information based on a comparison between the first set of parameters and the second set of parameters. The terminal device further determines second information based on the first information and predetermined condition information and transmits the second information to the network device. The second information indicates at least one of: status information related to a performance metric, a number related to the performance metric, or a percentage related to the performance metric. In this way, the terminal device or the network device knows how to report the performance metric of the AI/ML model, Based on the reported information related to the performance, NW can make reasonable and systematic decisions related to the AI/ML model for UE and provide reasonable configuration or indication information related to the AI/ML model for UE.

In the context of the presented application, the term “data processing model” used herein may refer to an algorithm that is used to process data. The term “AI/ML model” used herein may refer to a data driven algorithm that applies AI/ML techniques to generate a set of outputs based on a set of inputs. The term “AI/ML model” may be interchangeably with the term “data processing model” or “model.” The term “data collection” may refer to a process of collecting data by the network nodes, management entity, or UE for the purpose of AI/ML model training, data analytics and inference. The term “AI/ML model training” used herein may refer to a process to train an AI/ML Model [by learning the input/output relationship] in a data driven manner and obtain the trained AI/ML Model for inference. The term “AI/ML model inference” used herein can refer to a process of using a trained AI/ML model to produce a set of outputs based on a set of inputs. The term “performance metric” used herein may refer to measure data used to track and measure performance of model. The performance metric may directly or indirectly indicate the performances of the AI/ML model.

The term “AI/ML model validation” used herein may refer to a subprocess of training, to evaluate the quality of an AI/ML model using a dataset different from one used for model training, that helps selecting model parameters that generalize beyond the dataset used for model training. The term “model monitoring” used herein may refer to a procedure that monitors the inference performance of the AI/ML model.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-side (AI/ML) model” used herein may refer to a UE-side (AI/ML) model or a network-side (AI/ML) model. The term “two Two-sided (AI/ML) model” used herein may refer to a paired AI/ML Model(s) over which joint inference is performed, where joint inference includes AI/ML Inference whose inference is performed jointly across the UE and the network, i.e, the first part of inference is firstly performed by UE and then the remaining part is performed by gNB, or vice versa.

The term “model activation” used herein may refer to enabling an AI/ML model for a specific function. The term “model deactivation” used herein may refer to disabling an AI/ML model for a specific function. The term “model switching” used herein may refer to deactivating a currently active AI/ML model and activating a different AI/ML model for a specific function. The term “model management” used herein may refer to a more general term includes one or more of following functions/procedures: model activation, deactivation, selection, switching, fallback, and update (including re-training).

The term “supervised learning” used herein may refer to a process of training a model from input and its corresponding labels. The term “unsupervised learning” used herein may refer to a process of training a model without labelled data. The term “semi-supervised learning” used herein may refer to a process of training a model with a mix of labelled data and unlabelled data. The term “reinforcement Learning (RL)” used herein may refer to a process of training an AI/ML model from input (a.k.a. state) and a feedback signal (a.k.a. reward) resulting from the model's output (a.k.a. action) in an environment the model is interacting with.

The term “a beam” may refer to a reference signal or a reference signal resource. For example, a beam may refer to a channel state information reference signal (CSI-RS) or a CSI RS resource. Alternatively, a beam may refer to a synchronization signal/physical broadcast channel (PBCH) block (SSB) or a SSB resource. The term “beam identity (ID)” used herein may refer to a CSI-RS resource indicator (CRI) or SSB resource indicator (SSBR1). The term “measured layer 1 reference signal received power (L1-RSRP)” used herein may refer to a measured value of a L1-RSRP. It is equivalent to ideal L1-RSRP.

Principles and implementations of the present disclosure will be described in detail below with reference to the figures.

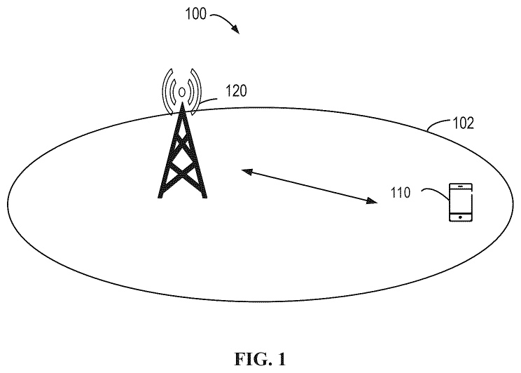

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the terminal device 110 may be a UE and the network device 120 may be a base station serving the UE. The serving area of the network device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

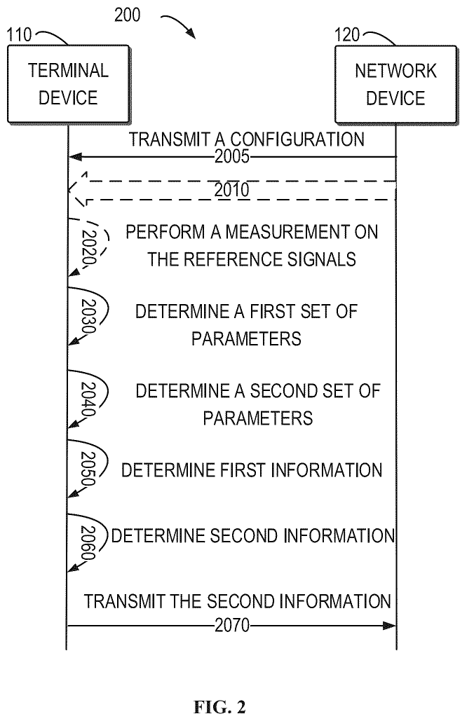

Reference is made to FIG. 2, which illustrates a signaling flow 200 of reporting angle information in accordance with some embodiments of the present disclosure. For the purposes of discussion, the signaling flow 200 will be discussed with reference to FIG. 1, for example, by using the terminal device 110 and the network device 120. It is noted that FIG. 2 is only an example embodiment.

The network device 120 may transmit (2005) a configuration to the terminal device 110. The configuration may indicate a first set of reference signals and/or resources of the first set of reference signals. In addition, the configuration may indicate a second set of reference signals and/or resources of the second set of reference signals. In some embodiments, the second set of reference signals may be a subset of the first set of reference signals. Alternatively, the second set of reference signals may be same as the first set of reference signals. In some other embodiments, the second set of reference signals may be different from the first set of reference signals. In some embodiments, the first set of reference signals and the second set of reference signals may refer to CSI-RSs. Alternatively, the first set of reference signals and the second set of reference signals may refer to SSBs. It is noted that the first set of reference signals and the second set of reference signals may refer to any proper types of reference signals.

In addition, the configuration may indicate a data processing model for monitoring. For example, the configuration may comprise an index of the data processing model. Alternatively, the configuration may comprise model parameters for the data processing model. The data processing model can be represented or indicated by (or replaced with) a model ID or functionality. For the case of CSI compression, the AI/ML model may be equivalent to CSI generation part or CSI reconstruction part.

The network device 120 may transmit (2010) a plurality of reference signals to the terminal device 110. For example, the plurality of reference signals includes the first set of reference signals and the second set of reference signals. As mentioned above, in some embodiments, the plurality of reference signals may be a plurality of CSI-RSs. Alternatively, or in addition, the plurality of reference signals may be a plurality of SSBs.

The terminal device 110 may perform (2020) a measurement on the plurality of reference signals. In some embodiments, the terminal device 110 may measure RSRPs of the plurality of reference signals. The terminal device 110 may determine received signal strength indicator (RSSI) of the plurality of reference signals. Alternatively, or in addition, the terminal device 110 may determine reference signal received quality (RSRQ) of the plurality of reference signals. In some other embodiments, the terminal device 110 may measure signal to interference noise ratio (SINR) of the plurality of reference signals. It is noted that the any proper type of measurements can be performed on the plurality of reference signals.

The terminal device 110 determines (2030) a first set of parameters based on a first measurement on the first set of reference signals. For example, in some embodiments, the terminal device 110 may determine a first set of beams based on RSRPs of the first set of reference signals. In this case, the first set of parameters may include the first set of beams. Alternatively, the first set of parameters may include first channel state information. Examples of the first set of parameters are described later in details.

The terminal device 110 determines (2040) a second set of parameters based on a second measurement on the second set of reference signals and the data processing model. For example, in some embodiments, the terminal device 110 may determine a second set of beams based on RSRPs of the second set of reference signals. In this case, the second set of parameters may include the second set of beams. Alternatively, the second set of parameters may include second channel state information. For example, the measured L1-RSRPs of the beams in the second set of reference signals are used as the input (i.e., one input sample) of the data processing model. The beam IDs of the top-K beams out of the beams in the first set of reference signals may be the output of the data processing model. Examples of the second set of parameters are described later in details.

The terminal device 110 determines (2050) first information based on a comparison between the first set of parameters and the second set of parameters. Examples of the first information are described later in details.

The terminal device 110 determines (2060) second information based on the first information and predetermined condition information. The second information indicates one or more of: status information related to a performance metric, a number related to the performance metric, a percentage related to the performance metric, or the first information. The term “status” used herein may be equivalent to one of: information, state or event. The terminal device 110 can determine a status based on a predefined criteria or condition. In some embodiments, if a predefined criteria/condition is satisfied, the terminal device 110 can determine the status corresponding to the predefined criteria. Examples of predetermined condition information and the status information are descried later.

In some embodiments, the performance metric may refer to a beam prediction accuracy. For example, the beam prediction metric may include a beam prediction accuracy (%) for Top-1 and/or Top-K beams. Top-1(%) may represent the percentage of “the Top-1 genie-aided beam is Top-1 predicted beam.” Top-K/1(%) may represent the percentage of “the Top-1 genie-aided beam is one of the Top-K predicted beams.” Top-1/K (%) may represent the percentage of “the Top-1 predicted beam is one of the Top-K genie-aided beams.” In some embodiments, the beam prediction metric may include a beam prediction accuracy (%) with 1 dB margin for Top-1 beam. The beam prediction accuracy (%) with 1 dB margin may be the percentage of the Top-1 predicted beam “whose ideal L1-RSRP is within 1 dB of the ideal L1-RSRP of the Top-1 genie-aided beam.”

Alternatively, or in addition, the performance metric may refer to a L1-RSRP difference between measured L1-RSRP and predicted L1-RSRP. For example, the L1-RSRP difference may include an average L1-RSRP difference of Top-1 predicted beam or a cumulative distribution function (CDF) of L1-RSRP difference for Top-1 predicted beam. The term “L1-RSRP difference of Top-1 predicted beam” may refer to the difference between the ideal L1-RSRP of Top-1 predicted beam and the ideal L1-RSRP of the Top-1 genie-aided beam.

In some other embodiments, the performance metric may include one or more of: link quality, throughout, L1-RSRP, or L1-SINR. The throughput may refer to one of: CDF of UE throughput, avg, and 5% ile UE throughput. The L1-RSRP/SINR may refer to measured L1-RSRP/SINR of the current/indicated link. In some embodiments, the performance metric may be about input/output data distribution, for example, data drift between training dataset and observed dataset, out-of-distribution detection.

In some embodiments, the performance metric may refer to an accuracy of AI/ML output CSI. For example, the performance metric may refer to CSI compression with two-sided model and temporal CSI prediction. In some embodiments, the performance metric may refer to SGCS, i.e., precoding matrix as AI/ML input/output. For example, if Rank=1, the performance metric may include one SGCS (e.g., 0≤SGCS≤1). If Rank>1, the performance metric may include one SGCS, e.g., average SGCS over all ranks, or weighted average SGCS over all ranks. Alternatively, if Rank>1, the performance metric may include separate SGCSs. In some embodiments, the performance metric may refer to NMSE, i.e., raw channel as AI/ML input/output with unit being dB. In some embodiments, the performance metric may include one or more of: equivalent MSE, received SNR, or numerical spectral efficiency gap.

The terminal device 110 transmits (2070) the second information to the network device 120. In some embodiments, the second information may be transmitted in uplink control information. Alternatively, or in addition, the second information may be transmitted in a medium access control control element (MAC CE).

As mentioned above, in some embodiments, the first set of parameters comprises a first set of beams, and the second set of parameters comprises a second set of beams. For example, the terminal device 110 may determine top-K1 beams (i.e., the first set of beams) in the first set of reference signals. The top-K1 beams in the first set of reference signals may refer to the beam IDs of the K1 beams having the largest measured L1-RSRP in the first set of reference signals. The top-K1 beams in the first set of reference signals determined based on the measured L1-RSRPs can be called as “top-K1 genie-aided beams”. In addition, based on the measured L1-RSRPs of the beams in the second set of reference signals and the data processing model, the terminal device 110 can directly or indirectly determine top-K2 beams (i.e., the second set of beams) in the first set of reference signals. The top-K2 beams in the first set of reference signals determined based on the data processing model can be called as “top-K2 predicted beams”. In some embodiments, the data processing model may be one of the followings: AI/ML model designed based on clarification where output of the AI/ML model is the beam IDs of the top-K2 predicted beams, it means that the terminal device 110 can directly determine the top-K2 predicted beams; and AI/ML model designed based on regression where output of the AI/ML model is the predicted or estimated values of the L1-RSRPs (called as “predicted L1-RSRP”) of the beams in the first set of reference signals, it means that the terminal device 110 can indirectly determine the top-K2 predicted beams based on the predicted L1-RSRPs of the beams in the first set of reference signals.

In some embodiments, the predetermined condition information may include a first predetermined condition. In this case, based on the comparison between the first set of beams and the second set of beams, the terminal device 110 may determine that the first information indicates whether the first set of beams overlaps with the second set of beams. In other words, the terminal device 110 may compare the first set of beams and the second set of beams to determine whether the first set of beams overlaps with the second set of beams. The terminal device 110 may determine whether the first information satisfies the first predetermined condition. The terminal device 110 may determine a first status that indicates the first predetermined condition is satisfied, if the first information satisfied the first predetermined condition. In this case, the second information may include the first status. For example, in some embodiments, the terminal device 110 may transmit a CSI report or a MAC CE carrying the first status. In some embodiments, a 1-bit CSI field can be introduced in a UCI, or a MAC-CE comprising a 1-bit field to indicate the first state. That is, the first status may be defined 1-bit value. It means that different bit values (i.e., 1 and 0) corresponds to different first statuses. In some other embodiments, the second information may include at least one first status, for example, multiple 1-bit fields are used to indicate the plurality of first statuses.

In some embodiments, the first predetermined condition may indicate that a first target beam in the first set of beams overlaps with the second set of beams. By way of example, the first target beam may refer to the beam with the highest L1-RSRP in the first set of beams. For example, the first predetermined condition may indicate that the top-1 genie-aided beam is one of the top-K2 predicted beams. In other words, the terminal device 110 may determine the first status where the top-1 genie-aided beam is one of the top-K2 predicted beams, if the top-1 genie-aided beam is one of the top-K2 predicted beams. The first predetermined condition may refer to that the beam ID of the top-1 genie-aided beam overlaps with (or is the same as) the beam ID of one beam out of the top-K2 predicted beams. For example, if K2=1, it means that the beam ID of the top-1 genie-aided beam overlaps with the beam ID of the top-1 predicted beam.

Alternatively, the first predetermined condition may indicate that the first target beam in the first set of beams does not overlap with the second set of beams. For example, the first predetermined condition may indicate that the top-1 genie-aided beam is not one of the top-K2 predicted beams. In other words, the terminal device 110 may determine the first status where the top-1 genie-aided beam is not one of the top-K2 predicted beams, if the top-1 genie-aided beam is not one of the top-K2 predicted beams. The first predetermined condition may refer to that the beam ID of the top-1 genie-aided beam does not overlap with (or is different from) the beam ID of any one beam out of the top-K2 predicted beams.

In some other embodiments, the first predetermined condition may indicate a second target beam in the second set of beams overlaps with the first set of beams. For example, the first predetermined condition may indicate that the top-1 predicted beam is one of the top-K1 genie-aided beams. In other words, the terminal device 110 may determine the first status where the top-1 predicted beam is one of the top-K1 genie-aided beams, if the top-1 predicted beam is one of the top-K1 genie-aided beams. The first predetermined condition may refer to that the beam ID of the top-1 predicted beam overlaps with (or is the same as) the beam ID of one beam out of the top-K1 genie-aided beams.

In some embodiments, the first predetermined condition may indicate the second target beam in the second set of beams does not overlap with the first set of beams. For example, the first predetermined condition may indicate that the top-1 predicted beam is not one of the top-K1 genie-aided beams. In other words, the terminal device 110 may determine the first status where the top-1 predicted beam is not one of the top-K1 genie-aided beams, if the top-1 predicted beam is not one of the top-K1 genie-aided beams. The first predetermined condition may refer to that the beam ID of the top-1 predicted beam does overlap with (or is different from) the beam ID of one beam out of the top-K1 genie-aided beams.

In some other embodiments, the terminal device 110 may determine third information based on the first set of beams and the second set of beams. The third information indicates which beam in the first set of beams overlap with first target beam in the second set of beams. In this case, the second information may include the first status, the third information and beam information of the first set of beams. In some embodiments, the beam information may include a beam ID of a beam (or a reference signal) and a beam quality of the beam (or the reference signal). By way of example, the terminal device 110 may determine which beam in the top-K genie-aided beams overlaps with the top-1 predicted beam based on the beam IDs of the top-K1 genie-aided beams and the beam IDs of the top-K2 predicted beams. Alternatively, the terminal device 110 may determine which beam in the top-K predicted beams overlaps with the top-1 genie-aided beam or which beam in the top-K predicted beams overlaps with the top-1 genie-aided beam. The terminal device 110 may report the top-K1 genie-aided beams and which beam in the top-K genie-aided beams overlaps with the top-1 predicted beam. For example, the terminal device 110 may report the beam IDs and the measured L1-RSRPs of the top-K1 genie-aided beams. In this case, the CSI report may be used for reporting the beam IDs and the measured L1-RSRPs of the top-K1 genie-aided beams. In some embodiments, the mapping order of different CSI fields indicating the beam IDs and the measured L1-RSRPs of the top-K1 genie-aided beams may be shown in Table 1. The value of K1 may be determined based on a configuration (e.g., nrofReportedRS) provided by the network device 120. Alternatively, the terminal device 110 may report the top-K1 genie-aided beams by using a new MAC-CE comprising the bit fields indicating the beam IDs and the measured L1-RSRPs.

TABLE 1

| CSI report | |
|---|---|
| number | CSI fields |
| CSI report #n | CRI or SSBRI #1 as in Table 6.3.1.1.2-6, if reported |
| | CRI or SSBRI #2 as in Table 6.3.1.1.2-6, if reported |
| | CRI or SSBRI #3 as in Table 6.3.1.1.2-6, if reported |
| | CRI or SSBRI #4 as in Table 6.3.1.1.2-6, if reported |
| | RSRP #1 as in Table 6.3.1.1.2-6, if reported |
| | Differential RSRP #2 as in Table 6.3.1.1.2-6, if reported |
| | Differential RSRP #3 as in Table 6.3.1.1.2-6, if reported |
| | Differential RSRP #4 as in Table 6.3.1.1.2-6, if reported |
| | CapabilityIndex #1 as in Table 6.3.1.1.2-6, if reported |
| | CapabilityIndex #2 as in Table 6.3.1.1.2-6, if reported |
| | CapabilityIndex #3 as in Table 6.3.1.1.2-6, if reported |
| | CapabilityIndex #4 as in Table 6.3.1.1.2-6, if reported |

In some embodiments, a M-bit CSI field may be included in a UCI for indicating the third information. Alternatively, a MEC CE including a M-bit field may be used to indicate the third information. The value of M (i.e., bitwidth for the M-bit field) may be determined based on (for example, equal to) the number of genie-aided beams to be reported (i.e., the value of K1), e.g., M=┌log 2K 1┌. For example, the bit value “00” indicates that the top-1 predicted beam is the first beam of the top-K1 genie-aided beams (i.e., the beam corresponding to CRI or SSBR1 #1). In addition, a 1-bit field may be needed. The 1-bit filed may be used to indicate whether the top-1 predicted beam is one of the top-K1 genie-aided beams. Further, if the 1-bit field indicates that the top-1 predicted beam is not one of the top-K1 genie-aided beams, the M-bit field (i.e., the third information) can be omitted or ignored. For example, a mapping order of the CSI field indicating the top-K1 genie-aided beams, M-bit CSI field indicating the first information and 1-bit CSI field indicating the second information in UCI may be determined based on Table 2.

TABLE 2

| CSI report | |
|---|---|
| number | CSI fields |
| CSI report #n | CRI or SSBRI #1 as in Table 6.3.1.1.2-6, if reported |
| | CRI or SSBRI #2 as in Table 6.3.1.1.2-6, if reported |
| | CRI or SSBRI #3 as in Table 6.3.1.1.2-6, if reported |
| | CRI or SSBRI #4 as in Table 6.3.1.1.2-6, if reported |
| | RSRP #1 as in Table 6.3.1.1.2-6, if reported |
| | Differential RSRP #2 as in Table 6.3.1.1.2-6, |
| | if reported |
| | Differential RSRP #3 as in Table 6.3.1.1.2-6, |
| | if reported |
| | Differential RSRP #4 as in Table 6.3.1.1.2-6, |
| | if reported |
| | CapabilityIndex #1 as in Table 6.3.1.1.2-6, if reported |
| | CapabilityIndex #2 as in Table 6.3.1.1.2-6, if reported |
| | CapabilityIndex #3 as in Table 6.3.1.1.2-6, if reported |
| | CapabilityIndex #4 as in Table 6.3.1.1.2-6, if reported |
| | 1-bit, indicating whether the top-1 predicted beam |
| | is one of the top-K genie-aided beams |
| | Third information (i.e., M-bit, indicating which beam in |
| | the top-K genie-aided beams overlaps with the top-1 |
| | predicted beam) |

Alternatively, the CSI report may be as Table 3.

TABLE 3

| CSI report number | CSI fields |
|---|---|
| CSI report #n | CRI or SSBRI #1 as in Table 6.3.1.1.2-6, if |
| | reported |
| | CRI or SSBRI #2 as in Table 6.3.1.1.2-6, if |
| | reported |
| | CRI or SSBRI #3 as in Table 6.3.1.1.2-6, if |
| | reported |
| | CRI or SSBRI #4 as in Table 6.3.1.1.2-6, if |
| | reported |
| | RSRP #1 as in Table 6.3.1.1.2-6, if reported |
| | Differential RSRP #2 as in Table 6.3.1.1.2-6, if |
| | reported |
| | Differential RSRP #3 as in Table 6.3.1.1.2-6, if |
| | reported |
| | Differential RSRP #4 as in Table 6.3.1.1.2-6, if |
| | reported |
| | CapabilityIndex #1 as in Table 6.3.1.1.2-6, if |
| | reported |
| | CapabilityIndex #2 as in Table 6.3.1.1.2-6, if |
| | reported |
| | CapabilityIndex #3 as in Table 6.3.1.1.2-6, if |
| | reported |
| | CapabilityIndex #4 as in Table 6.3.1.1.2-6, if |
| | reported |
| | 1-bit, indicating whether the top-1 predicted CRI |
| | or SSBRI is one of the top-K genie-aided |
| | CRI/SSBRIs (e.g., CRI or SSBRI #1~CRI or |
| | SSBRI #4) |
| | Third information (M-bit, indicating which the |
| | top-1 predicted CRI or SSBRI is one of the top- |
| | K genie-aided CRI/SSBRIs (e.g., CRI or SSBRI |
| | #1~CRI or SSBRI #4)) |

In some embodiments, the first set of parameters comprises a first measured beam quality of a first beam in the first set of beams, and the second set of parameters comprises a second measured beam quality of a second beam in the second set of beams. Alternatively, the first set of parameters comprises a first set of measured beam qualities of beams in the first set of beams, and the second set of parameters comprises a second set of predicted beam qualities of beams in the second set of beams. In this case, the predetermined condition information may include a second predetermined condition. By way of example, the first beam may be the first target beam (i.e., the beam with the highest L1 RSRP) in the first set of beams and the second beam may refer to the first target beam in the second set of beams. Alternatively, the first beam may be same as the second beam. In some embodiments, the terminal device 110 may determine the first information based on the comparison between the first measured beam quality and the second measured beam quality. The first information may indicate a first difference between the first measured beam quality and the second measured beam quality. For example, the terminal device 110 may determine the first difference based on the measured L1-RSRP of the top-1 genie-aided beam and the measured L1-RSRP of the top-1 predicted beam. The terminal device 110 may determine whether the first information satisfies the second predetermined condition. If the first information satisfies the second predetermined condition, the terminal device 110 may determine a second status that indicates the second predetermined condition is satisfied. In this case, the second information may include the second status, By way of example, the terminal device 110 may determine the second status based on the second predetermined condition, the measured L1-RSRP of the top-1 genie-aided beam and the measured L1-RSRP of the top-1 predicted beam. Alternatively, the terminal device 110 may determine the second status based on the second predetermined condition, the measured L1-RSRPs of the beams in the first set of reference signals and the predicted L1-RSRPs of the beam in the first set of reference signals. The terminal device 110 may report the second status to the network device 120. In this case, in some embodiments, the second status may be transmitted in UCI or MAC CE.

In some embodiments, the second predetermined condition may indicate that the first difference is less than or equal to a first threshold. For example, the second predetermined condition may indicate that the difference between the measured L1-RSRP of the top-1 predicted beam and the measured L1-RSRP of the top-1 genie-aided beam is less than or equal to a threshold (i.e., the first threshold) (e.g., 1 dB). The difference used herein may refer to the measured value of the difference or the absolute value of the measured value of the different. As another example, the second predetermined condition may indicate that the difference between the predicted L1-RSRP of a beam in the first set of reference signals and the measured L1-RSRP of the beam is less than or equal to a threshold (i.e., the first threshold) (e.g., 1 dB).

Alternatively, the second predetermined condition may indicate that the first difference is larger than or equal to the first threshold. By way of example, the second predetermined condition may indicate that the difference between the measured L1-RSRP of the top-1 predicted beam and the measured L1-RSRP of the top-1 genie-aided beam is larger than or equal to a threshold (i.e., the first threshold). As another example, the second predetermined condition may indicate that the difference between the predicted L1-RSRP of a beam in the first set of reference signals and the measured L1-RSRP of the beam is larger than or equal to the threshold (i.e., the first threshold). The second predetermined condition may be applicable to the data processing model based on classification or regression.

In some embodiments, the terminal device 110 may determine the first information based on the comparison between the first set of measured beam qualities and the second set of predicted beam qualities. In this case, the first information may indicate a first set of differences between the first set of measured beam qualities and the second set of predicted beam qualities, or a statistic of the first set of differences. For example, the terminal device 110 may compare the first set of measured beam qualities and the second set of predicted beam qualities to determine the first et of differences. The terminal device 110 may determine a second status that indicates the second predetermined condition is satisfied, if the first information satisfies the second predetermined condition. In this case, the second information may include the second status.

In some embodiments, the second predetermined condition may indicate the number of second differences in the first set of differences is less than or equal to a second threshold. For example, the second predetermined condition may indicate the number (or percentage) of beams (i.e., differences) satisfying the above mentioned first threshold is less than or equal to a threshold (i.e., the second threshold) in the first set of reference signals. Alternatively, the second predetermined condition may indicate the number of second differences in the first set of difference is larger than or equal to the second threshold. For example, the second predetermined condition may indicate the number (or percentage) of beams (i.e., differences) satisfying the above mentioned first threshold is larger than or equal to a threshold (i.e., the second threshold) in the first set of reference signals. The second difference may refer to a difference that is less than or equal to a threshold, or larger than or equal to a third threshold.

In some embodiments, a statistic of the first set of differences may be less than or equal to a fourth threshold. For example, the statistic of differences between the predicted L1-RSRPs of all beams in the first set of reference signals and the measured L1-RSRPs of the beams is less than or equal to a threshold (i.e., the fourth threshold). Alternatively, the statistic of the first set of differences may be larger than or equal to a fourth threshold. For example, the statistic of differences between the predicted L1-RSRPs of all beams in the first set of reference signals and the measured L1-RSRPs of the beams is larger than or equal to a threshold (i.e., the fourth threshold). The statistic may include one or more of the followings of the first set of differences: mean, variance, standard deviation, minimum, median, or maximum.

In some embodiments, each beam in the first set of reference signals may correspond to a second status. For example, the terminal device 110 may report the second statuses corresponding to all beams in the first set of reference signals. In other words, the second information may include the second statuses corresponding to all beams in the first set of reference signals. In this case, the mapping order of 1-bit fields indicating the second states in UCI or MAC-CE can be determined based on the beam IDs of the beams corresponding to the second states, e.g., ascending (or descending) order of the beam IDs.

In addition, the terminal device 110 may report the first status and the second status. For example, the second information may include the first status and the second status. In this case, the first status and the second status may be reported by using the same CSI report or MAC-CE. For example, a mapping order of 1-bit CSI field indicating the first state and 1-bit CSI field indicating the second state in UCI can be determined based on Table 4. In some embodiments, the terminal device 110 may report one or more second statuses, for example, a plurality 1-bit fields are sued to indicate a plurality of second statuses.

TABLE 4

| CSI report number | CSI fields |
|---|---|
| CSI report #n | 1-bit CSI field indicating the first status |
| | 1-bit CSI field indicating the second status |

In some embodiments, the terminal device 110 determines a L1-RSRP difference based on the measured L1-RSRP of the top-1 genie-aided beam and the measured L1-RSRP of the top-1 predicted beam. Alternatively, the terminal device 110 may determine the measured L1-RSRPs of the beams in the Set A and the predicted L1-RSRPs of the beam in the Set A. In this case, the terminal device 110 may report the L1-RSRP difference to the network device 120. The second information may include the L1-RSRP difference.

In some embodiments, the L1-RSRP may be the difference between the measured L1-RSRP of the top-1 predicted beam and the measured L1-RSRP of the top-1 genie-aided beam. L1-RSRP difference 1 can be applicable to an AI/ML model designed based on classification or regression. In some embodiments, the L1-RSRP difference may be difference between the predicted L1-RSRP of a beam in Set A and the measured L1-RSRP of the beam. Alternatively, or in addition, the L1-RSRP difference may be a statistic (e.g., mean, variance, standard deviation, minimum, median, maximum) of the differences between the predicted L1-RSRPs of all beams in Set A and the measured L1-RSRPs of the beams.

In some embodiments, for reporting the L1-RSRP difference, a M1-bit CSI field can be introduced in a UCI. Alternatively, a MAC-CE comprising a M1-bit field may indicate the L1-RSRP difference. The M1-bit (CSI) field may include at least one the followings: a M2-bit field indicating a reported value of L1-RSRP difference (called as “reported L1-RSRP difference”) corresponding to (the absolute value of) the measured value of a L1-RSRP difference (called as “measured L1-RSRP difference”). For example, a mapping between the reported L1-RSRP difference and the measured L1-RSRP difference can be Table 5. Intervals between a1 and a2, a2 and a3 shown in Table 5 can be the same (e.g., determined based on a step size (e.g., 1 dB)) or different. The value of M2 (i.e., bitwidth for the M2-bit field) can be determined based on the value of A, e.g., M2=┌log₂ A┐, or M2=┌log₂ (A+1)┐, or M2=┌log₂ A┐+1. In some embodiments, a 1-bit field indicating whether the measured value of the (corresponding) L1-RSRP difference may be positive or negative.

TABLE 5

| Reported L1-RSRP difference | Measured L1-RSRP difference |
|---|---|
| 0 | 0 ≤ L1-RSRP difference < a₁ |
| 1 | a₁ ≤ L1-RSRP difference < a₂ |
| 2 | a₂ ≤ L1-RSRP difference < a₃ |
| . . . | . . . |
| A | a_{A} ≤ L1-RSRP difference |

Furthermore, when the L1-RSRP difference is L1-RSRP difference 2, each beam in the first set of reference signals may correspond to a L1-RSRP difference. In this case, the terminal device 110 may need to report the L1-RSRP differences corresponding to all beams in the first set of reference signals. In this case, the mapping order of the M1-bit fields indicating the L1-RSRP differences in UCI or MAC-CE can be determined based on the beam IDs of the beams corresponding to the L1-RSRP differences, e.g., ascending (or descending) order of the beam IDs. When the L1-RSRP difference is L1-RSRP difference 3, the terminal device 110 may report multiple L1-RSRP differences, e.g., a mean and a variance of the differences between the predicted L1-RSRPs of all beams in first set of reference signals and the measured L1-RSRPs of the beams.

In some embodiments, the terminal device 110 may determine the first information based on the comparison between the first set of measured beam qualities and the second set of predicted beam qualities. The first information may indicate a first set of differences between the first set of measured beam qualities and the second set of predicted beam qualities. The terminal device 110 may determine a first number of differences based on the first set of differences and the second predetermined condition. In this case, the second information transmitted by the terminal device 110 may include the first number of differences. Alternatively, or in addition, the terminal device 110 may determine a second set of differences based on the first set of differences and the second predetermined condition. The second set of differences may include a subset of differences from the first set of differences which satisfies the second predetermined condition. In this case, the second information may also include the second set of differences. For example, the terminal device 110 may determine L1-RSRP differences (e.g., L1-RSRP difference 2) corresponding to all beams in the first set of reference signals based on the measured L1-RSRPs of all beams in the first set of reference signals and the predicted L1-RSRPs of the beams. The terminal device 110 may determine a number of L1-RSRP difference satisfying the second predetermined condition. The L1-RSRP differences satisfying the predefined criteria may be determined based on a predefined criteria and the L1-RSRP differences. The terminal device 110 may report the number of L1-RSRP differences satisfying the second predetermined condition (called as “number of satisfied L1-RSRP differences” for short). Optionally, the terminal device 110 may also report the L1-RSRP differences satisfying the predefined criteria (called as “satisfied L1-RSRP difference” for short).

In some embodiments, the second predetermined condition may include the difference is less than or equal to a fifth threshold. Alternatively, the second predetermined condition may include the difference is larger than or equal to the fifth threshold. In some embodiments, for reporting of the number of satisfied L1-RSRP differences, a M3-bit CSI field can be introduced in a UCI. Alternatively, a MAC-CE comprising a M3-bit field may be transmitted to indicate the number of satisfied L1-RSRP differences. The value of M3 (i.e., bitwidth for the M3-bit field) can be determined based on the number of beams in the first set of reference signals (represented as “Num_Beam”), e.g., M3=┌log₂ (Num_Beam+1)┐, or M3=┌log₂ Num_Beam┐+1.

In some embodiments, the terminal device 110 may report the number of satisfied L1-RSRP differences and the satisfied L1-RSRP differences simultaneously, i.e., the number of satisfied L1-RSRP differences and the satisfied L1-RSRP differences are reported by using the same CSI report or MAC-CE. Further, the terminal device 110 can report the number of satisfied L1-RSRP differences in part 1 of a CSI report and report the satisfied L1-RSRP differences in part 2 of the CSI report. In this case, the terminal device 110 and the network device 120 may determine the number of satisfied L1-RSRP differences to be reported in part 2 of the CSI report that can be determined based on (e.g., equal to) the number of satisfied L1-RSRP differences indicated in part 1 of the CSI report. For example, part 1 of the CSI report comprises one M3-bit CSI field and part 2 of the CSI report comprises N1 M1-bit fields. The value of N1 may be determined based on the number of satisfied L1-RSRP differences indicated in part 1 of the CSI report.

In some other embodiments, in addition to the satisfied L1-RSRP differences, the beam IDs corresponding to the satisfied L1-RSRP differences may be reported in part 2 of the CSI report. For example, a mapping order of M3-bit CSI field indicating the number of satisfied L1-RSRP differences, M1-bit CSI field indicating the satisfied L1-RSRP difference and CSI field indicating the beam ID (i.e., CRI or SSBR1) in UCI can be determined based on the Table 6 where assuming the number of satisfied L1-RSRP differences is 4. In this case, the mapping order of the beam IDs and the satisfied L1-RSRP differences can be determined based on the beam IDs (of the beams corresponding to the satisfied L1-RSRP differences), e.g., ascending (or descending) order of the beam IDs.

TABLE 6

| CSI report | |
|---|---|
| number | CSI fields |
| CSI report #n | M3-bit CSI field indicating the number of |
| CSI part 1 | satisfied L1-RSRP differences |
| CSI report #n | Beam ID #1 |
| CSI part 2 | (i.e., first beam ID) |
| | M1-bit CSI field indicating the satisfied L1-RSRP |
| | difference #1 (i.e., first satisfied L1-RSRP difference) |
| | Beam ID #2 |
| | M1-bit CSI field indicating the satisfied L1-RSRP |
| | difference #2 |
| | Beam ID #3 |
| | M1-bit CSI field indicating the satisfied L1-RSRP |
| | difference #3 |
| | Beam ID #4 |
| | M1-bit CSI field indicating the satisfied L1-RSRP |
| | difference #4 |

Additionally, the terminal device 110 may determine and report a number of beams satisfying the second predetermined condition. The second predetermined condition may include that the L1-RSRP difference corresponding to the beam is less than or equal to a threshold; or the L1-RSRP difference corresponding to the beam is larger than or equal to a threshold. That is, the L1-RSRP differences corresponding to the beams may be one of: the L1-RSRP difference corresponding to the beam is less than or equal to a threshold; or the L1-RSRP difference corresponding to the beam is larger than or equal to a threshold. In other words, the “number of satisfied L1-RSRP differences” and the “satisfied L1-RSRP differences” above mentioned can be replaced with “number of beams satisfying a predefined criterion” and “L1-RSRP differences corresponding to the beams”.

In some embodiments, the first set of parameters comprises a first set of reference signals, and the second set of parameters comprises a second set of reference signals. The predetermined condition information may include a first predetermined condition. In this case, the terminal device 110 may determine the first information indicating whether the first set of reference signals overlaps with the second set of reference signals based on the comparison between the first set of reference signals and the second set of reference signals. If the first information satisfies the first predetermined condition, the terminal device 110 may determine a first status that indicates the predetermined condition is satisfied. In this case, the terminal device 110 may transmit the second information that includes the first status. In some embodiments, the second information may be transmitted in UCI or a MAC CE.

In some embodiments, the first predetermined condition indicates a first target reference signal in the first set of reference signals overlaps with the second set of reference signals. Alternatively, the first predetermined condition may indicate the first target reference signal in the first set of reference signals does not overlap with the second set of reference signals. In some other embodiments, the first predetermined condition may indicate a second target reference signal in the second set of reference signals overlaps with the first set of reference signals. Alternatively, the first predetermined condition may indicate the second target reference signal in the second set of reference signals does not overlap with the first set of reference signals.

In some embodiments, the terminal device 110 may determine third information based on the first set of reference signals and the second set of reference signals. The third information may indicate which reference signal in the first set of reference signals overlaps with the first target reference signal in the second set of reference signals. In this case, the second information transmitted to the network device 120 may include the first status, the third information and information of the first set of reference signals. Alternatively, if the first status indicates the first target reference signal in the first set of reference signals does not overlap with the second set of reference signal, the third information may be omitted.

In some embodiments, the first set of parameters comprises a first measured signal quality of a first reference signal in the first set of reference signals, and the second set of parameters comprises a second measured signal quality of a second reference signal in the second set of reference signals. Alternatively, the first set of parameters may include a first set of measured signal qualities of reference signals in the first set of reference signals, and the second set of parameters comprises a second set of predicted signal qualities of reference signals in the second set of reference signals. The predetermined condition information may include a second predetermined condition. In some embodiments, the first reference signal refers to a first target reference signal in the first set of reference signals and the second reference signal refers to the first target reference signal in the second set of reference signals. Alternatively, the first reference signal may be same as the second reference signal.

In some embodiments, the terminal device 110 may determine the first information based on the comparison between the first measured signal quality and the second measured signal quality. The first information may indicate a first difference between the first measured signal quality and the second measured signal quality. If the first information satisfies a second predetermined condition, the terminal device 110 may determine a second status that indicates the second predetermined condition is satisfied. The terminal device 110 may also transmit to the network device 120, the second information including the second status. In some embodiments, the second predetermined condition indicates one of: the first difference is less than or equal to a first threshold, or the first difference is larger than or equal to the first threshold.

In some embodiments, the terminal device 110 may determine the first information based on the comparison between the first set of measured signal qualities and the second set of predicted signal qualities. The first information may indicate a first set of differences between the first set of measured signal qualities and the second set of predicted signal qualities, or a statistic of the first set of differences. If the first information satisfies the second predetermined condition, the terminal device 110 may determine a second status that indicates the second predetermined condition is satisfied. In this case, the second information transmitted to the network device 120 may include the second status. In some embodiments, the second predetermined condition may indicate one of: the number of second differences in the first set of differences is less than or equal to a second threshold, or the number of second differences in the first set of differences is larger than or equal to the second threshold. The second difference may refer to a difference that is less than or equal to a threshold, or larger than or equal to a third threshold. Alternatively, the second predetermined condition may indicate a statistic of the first set of differences is less than or equal to a fourth threshold, or the statistic is larger than or equal to the fourth threshold. In some embodiments, the second information comprises the first status and the second status.

In some other embodiments, the terminal device 110 may determine the first information based on the comparison between the first set of measured signal qualities and the second set of predicted signal qualities. The first information may indicate a first set of differences between the first set of measured signal qualities and the second set of predicted signal qualities. The terminal device 110 may also determine a first number of differences based on the first set of differences and the second predetermined condition. In this case, the terminal device 110 may transmit to the network device 120, the second information including the first number of differences. In some embodiments, the second predetermined condition may include the difference is less than or equal to a fifth threshold. Alternatively, the second predetermined condition may include the difference is larger than or equal to the fifth threshold.

In some embodiments, the first set of parameters may include first channel state information, and the second set of parameters may include second channel state information. The predetermined condition may include a third predetermined condition. For example, the terminal device 110 may be provided with at least one of the following configuration or indication information for model monitoring: a CSI-RS or an AI/ML model (or a CSI generation part and a CSI reconstruction part). Based on the received CSI-RS, the terminal device 110 may determine a precoding matrix or raw channel that can reflect channel (information/quality/state). The precoding matrix may refer to a group of eigenvectors or an eTypeII-like precoding matrix indicator (PMI). The raw channel (i.e., full Tx*Rx multi-input-multi-output (MIMO) channel) may refer to a raw channel in frequency domain, time delay domain, transformed delay/frequency domain. The determined precoding matrix or raw channel can be called as “input CSI” or “target CSI”. Based on the input CSI and the data processing model, the terminal device 110 can determine a recovered precoding matrix or raw channel. Specifically, the input CSI is used as the input of the data processing model, the output of the data processing model is the recovered precoding matrix or raw channel. The recovered precoding matrix or raw channel can be called as “output CSI”.

In some embodiments, the terminal device 110 may determine the first information based on the comparison between the first channel state information and the second channel state information. The first information may indicate a squared generalized cosine similarity (SGCS) or normalized mean squared error (NMSE). The SGCS may include one of: a SGCS associated with or corresponding to a rank (for example, rank=1), layer or data processing model, an averaged SGCS corresponding to the list of ranks (for example, rank=1, 2, 3, 4), layers or data processing models, or a statistic of SGCSs corresponding to the list of ranks, layers or data processing models. The NMSE may include one of: a NMSE associated with or corresponding to a data processing model, or a statistic of NMSEs corresponding to the list of data processing models. The terminal device 110 may determine whether the first information satisfies a third predetermined condition. If the first information satisfies the third predetermined condition, the terminal device 110 may determine a third status that indicates the third predetermined condition is satisfied. In this case, the second information transmitted to the network device 120 may include the third status. By way of example, the terminal device 110 may determine a SGCS or NMSE based on an input CSI and corresponding output CSI. The terminal device 110 may further determine a third status based on a third predefined criteria and the SGCS or NMSE. The terminal device 110 may report the third status to the network device 120.

In some embodiments, the third predetermined condition indicates a SGCS is larger than or equal to a sixth threshold. Alternatively, the third predetermined condition may indicate the SGCS is less than or equal to the sixth threshold. For determination of the rank, layer or data processing model, it (i.e., rank, layer or data processing model) can be provided by a configuration or indication information, e.g., an indicator of rank, layer or data processing model. Optionally, it can be a predefined rank, layer or AI/ML model, e.g., based on the lowest (or largest) rank, layer or model ID (in a list of configured or indicated ranks, layers or AI/ML models).

In some embodiments, the third predetermined condition may indicate that the average or weighted SGCS corresponding to a list of ranks, layers or data processing models is larger than or equal to a threshold. The list of ranks, layers or data processing models can be provided by a configuration or indication information, e.g., the list of ranks is provided with the configuration related to “RI-Restriction” (e.g., ri-Restriction, typeII-RI-Restriction, typeII-RI-Restriction-r16). The list of ranks, layers or data processing model may be equivalent to the configured or indicated ranks, layers or AI/ML models. In some other embodiments, the third predetermined condition may indicate that the average or weighted SGCS corresponding to a list of ranks, layers or AI/ML models is less than or equal to a threshold.

In some embodiments, the third predetermined condition may indicate that a statistic (e.g., mean, variance, standard deviation, minimum, median, maximum) of the SGCSs corresponding to a list of ranks, layers or AI/ML models is larger than or equal to a threshold. Alternatively, or in addition, the third predetermined condition may indicate that a statistic of the SGCSs corresponding to a list of ranks, layers or AI/ML models is less than or equal to a threshold.

In some embodiments, the third predetermined condition may indicate that the number of SGCSs that are larger than or equal to the sixth threshold is larger than or equal to a tenth threshold. Alternatively, or in addition, the third predetermined condition may indicate that the number of SGCSs that are larger than or equal to the sixth threshold is less than or equal to the tenth threshold.

Alternatively, or in addition, the third predetermined condition may indicate that the NMSE is less than or equal to a ninth threshold, the NMSE is larger than or equal to the ninth threshold. In some other embodiments, the third predetermined condition may indicate that the number of NMSEs that are less than or equal to the seventh threshold is larger than or equal to an eleventh threshold. In some embodiments, the third predetermined condition may indicate that the number of NMSEs that are less than or equal to the seventh threshold is less than or equal to the eleventh threshold.

In some embodiments, each rank/layer/AI/ML model may corresponds to a third status. In this situation, the terminal device 110 may need to report the third status corresponding to all configured or indicated ranks, layers or AI/ML models. In this case, the mapping order of 1-bit fields indicating the third states in UCI or MAC-CE can be determined based on the indicators of the ranks, layers or AI/ML models corresponding to the third states, e.g., ascending (or descending) order of the indicators. In some embodiments, the terminal device 110 can report at least one third state, e.g., multiple 1-bit fields are used to indicate multiple third states.

In some embodiments, the terminal device 110 may determine a SGCS or NMSE based on an input CSI and corresponding output CSI. In this case, the terminal device 110 may report the SGCS or NMSE to the network device 120. In some embodiments, for reporting the SGCS or NMSE, a new M4-bit CSI field can be introduced in a UCI, or a new MAC-CE comprising a M4-bit field to indicate the SGCS or NMSE, i.e., the SGCS or NMSE can be defined M4-bit value. By way of example, the M4-bit field may indicate a reported value of SGCS or NMSE (called as “reported SGCS or NMSE”) corresponding to the measured value of a SGCS or NMSE (called as “measured SGCS or NMSE”). For example, a mapping between the reported SGCS or NMSE and the measured SGCS or NMSE can be the following Tables 7 and 8. In some embodiments, intervals between b0 and b1, b1 and b2, . . . , or c1 and c2, c2 and c3, and the like can be the same (e.g., determined based on a step size) or different. The value of M4 (i.e., bitwidth for the M4-bit field) can be determined based on the value of B or C, e.g., M4=┌log₂ B/C┐, or M4=┌log₂ (B/C+1)┐, or M4=┌log₂ B/C┐+1.

TABLE 7

| Reported SGCS | Measured SGCS |
|---|---|
| 0 | b₀ (e.g., 0) ≤ SGCS < b₁ |
| 1 | b₁ ≤ SGCS < b₂ |
| 2 | b₂ ≤ SGCS < b₃ |
| . . . | . . . |
| B | b_{B-1} ≤ SGCS ≤ b_{B} (e.g., 1) |

TABLE 8

| Reported NMSE | Measured NMSE (Unit: dB) |
|---|---|
| 0 | NMSE < c₁ |
| 1 | c₁ ≤ NMSE < c₂ |
| 2 | c₂ ≤ NMSE < c₃ |
| . . . | . . . |
| C | c_{C} ≤ NMSE |

Furthermore, in some embodiments, when each rank, layer or AI/ML model corresponds to a SGCS or NMSE, the terminal device 110 may need to report the SGCSs or NMSEs corresponding to all configured or indicated ranks, layers or AI/ML models. In this case, the mapping order of the M4-bit fields indicating the SGCSs or NMSEs in UCI or MAC-CE can be determined based on the indicators of the ranks, layers or AI/ML models corresponding to the SGCSs or NMSEs, e.g., ascending (or descending) order of the indicators of the ranks, layers or AI/ML models.

In some embodiments, the terminal device 110 may determine SGCSs or NMSEs based on the comparison between the first channel state information and the second channel state information. The terminal device 110 may determine a first set of SGCs or NMSEs based on the SGCSs or NMSEs and the predetermined condition. In this case, in some embodiments, the second information transmitted by the terminal device 110 may include one or more of: indicators of rank, layer or data processing model of the first set of SGCSs or NMSEs, or the first set of SGCSs or NMSEs. Alternatively, the second information transmitted by the terminal device 110 may include one or more of: indicators of rank, layer or data processing model of the SGCSs or NMSEs, or the SGCSs or NMSEs. In some embodiments, the third predetermined condition may include the first set of SGCSs comprises N1 SGCSs having largest values in the SGCSs. Alternatively, the third predetermined condition may include the first set of NMSEs comprises N1 NMSEs having lowest values in the NMSEs. N1 may be an integer number.

In some embodiments, the terminal device 110 may determine SGCSs or NMSEs corresponding to the configured or indicated ranks, layers or AI/ML models based on the input CSI and corresponding output CSI. The terminal device 110 may determine a first set of SGCSs or NMSEs based on the determined SGCSs or NMSEs. In this case, the terminal device 110 may report the indicators of the ranks, layers or AI/ML models corresponding to the first set of SGCSs or NMSEs (represented as “first set of indicators” for short) and the first set of SGCSs or NMSEs (optionally) to the network device 120.

In some embodiments, the first set of SGCSs or NMSEs may include the SGCSs or NMSEs corresponding to the configured or indicated ranks, layers or AI/ML models. It means that the first set of indicators includes the indicators of the configured or indicated ranks, layers or AI/ML models. Alternatively, the first set of SGCSs or NMSEs may include top-N2 SGCSs or NMSEs out of the SGCSs or NMSEs corresponding to the configured or indicated ranks, layers or AI/ML models. In some embodiments, the top-N2 SGCSs out of the SGCSs may refer to N2 SGCSs having the largest value of SGCS in the SGCSs. Alternatively, the top-N2 NMSEs out of the NMSEs may refer to having the lowest value of NMSE in the NMSEs. The value of N2 can be provided by a new configuration or indication information. For example, it can be a positive integer not larger than the number of the configured or indicated ranks, layers or AI/ML models.

In some embodiments, for reporting one indicator in the first set of indicators, a new or legacy M5-bit CSI field can be introduced in a UCI, or a new MAC-CE comprising a M5-bit field to indicate an indicator, e.g., reusing legacy “RI” filed to indicate the indicator of a rank, using new “layer ID” or “model ID” field to indicate the indicator of a layer, an AI/ML model. The value of M5 may be determined based on the number of the configured or indicated ranks, layers or AI/ML models, e.g., M5=┌log₂ (Number of Ranks, layers or models)┐.

In some embodiments, for reporting the first set of indicators, N2 M5-bit field can be used to indicate the first set of indicators. Specifically, the mapping order of the N2 M5-bit field can be determined based on the values of the first set of SGCSs or NMSEs, e.g., descend order (i.e., from large to small) for SGCS, ascending order for NMSE, as shown in Table 9.

TABLE 9

| CSI report number | CSI fields |
|---|---|
| CSI report #n | Indicator #1 in the first set of indicators |
| | (e.g., indicator corresponding to the largest |
| | SGCS, the lowest NMSE) |
| | Indicator #2 in the first set of indicators |
| | . . . |
| | Indicator #N2 in the first set of indicators |

Optionally, in addition to the first set of indicators, the terminal device 110 can also report the first set of SGCSs or NMSEs by using the same CSI report or MAC-CE. For example, a mapping order of N2 M5-bit CSI fields indicating the first set of indicators, N2 M4-bit CSI fields indicating the first set of SGCSs or NMSEs in UCI can be determined based on the Table 10.

TABLE 10

| CSI report number | CSI fields |
|---|---|
| CSI report #n | Indicator #1 in the first set of indicators |
| | SGCS or NMSE corresponding to Indicator #1 |
| | (e.g., the largest SGCS, the lowest NMSE) |
| | Indicator #2 in the first set of indicators |
| | SGCS or NMSE corresponding to Indicator #2 |
| | . . . |
| | Indicator #N2 in the first set of indicators |
| | SGCS or NMSE corresponding to Indicator #N2 |

In some embodiments, the terminal device 110 may determine a number or percentage of occurrences of the first status based on a plurality of monitored results of the data processing model. In this case, the second information transmitted from the terminal device 110 to the network device 120 may indicate the number or percentage of occurrences of the first status. By way of example, after completing N (N>1) times of model monitoring, the terminal device 110 can determine N monitored results. Specifically, for each model monitoring, the terminal device 110 needs to determine whether a first status occurs based on the beam IDs of the top-K1 genie-aided beams and the beam IDs of the top-K2 predicted beams determined during this model monitoring. The terminal device 110 may determines the number or percentage of occurrences of the first status based on the N monitored results. In this case, the terminal device 110 may report the number or percentage to the network device 120.

In some embodiments, for reporting the number, a M6-bit CSI field can be introduced in a UCI, or a MAC-CE comprising a M6-bit field to indicate the number. The value of M6 (i.e., bitwidth for the M6-bit field) can be determined based on the value of N (i.e., number of times of model monitoring), e.g., M6=┌log₂ (N+1)┐, or M6=┌log₂ N┐+1.

Alternatively, or in addition, for reporting of the percentage is similar to the L1-RSRP difference, a M7-bit CSI field can be introduced in a UCI, or a MAC-CE comprising a M7-bit field to indicate a reported value of the percentage (called as “reported percentage”) corresponding to the measured or determined value of a percentage (called as “measured percentage”). For example, a mapping between the reported L1-RSRP difference and the measured L1-RSRP difference can be Table 11. In some embodiments, intervals between a1 and a2, a2 and a3 and the like can be the same (e.g., determined based on a step size (e.g., 20%)) or different. The value of M7 (i.e., bitwidth for the M7-bit field) can be determined based on the value of A, e.g., M7=┌log₂A┐, or M7=┌log₂ (A+1)┐, or M7=┌log₂A┐+1.

TABLE 11

| Reported percentage | Measured percentage |
|---|---|
| 0 | 0 ≤ percentage < a1 |
| 1 | a1 ≤ percentage < a2 |
| 2 | a2 ≤ percentage < a3 |
| . . . | . . . |
| A | aA ≤ percentage ≤ 100% |

In some embodiments, the terminal device 110 may determine a number or percentage of occurrences of the first status based on a plurality of monitored results of the data processing model. The terminal device 110 may determine whether the number or percentage of occurrences of the first status satisfies a fourth predetermined condition. If the number or percentage of occurrences of the first status satisfies a fourth predetermined condition, the terminal device 110 may determine a fourth status that indicates the fourth predetermined condition is satisfied. In this case, the second information transmitted by the terminal device 110 to the network device 120 may include the fourth status. In some embodiments, the second information may be transmitted in UCI. Alternatively, the second information may be transmitted in MAC CE. In some embodiments, the fourth predetermined condition may indicate the number or percentage of occurrences of the first status is larger than or equal to a twelfth threshold. Alternatively, the fourth predetermined condition may indicate the number or percentage of occurrences of the first status is less than or equal to the twelfth threshold.

Alternatively, the terminal device 110 may determine a number or percentage of occurrences of the second status based on a plurality of monitored results of the data processing model. By way of example, after completing N (N>1) times of model monitoring, the terminal device 110 can determine N monitored results. Specifically, for each model monitoring, the terminal device 110 needs to determine whether a second status occurs. The terminal device 110 may determine a number or percentage of occurrences of the second state based on the N monitored results. In some embodiments, the terminal device 110 may transmit to the network device 120, the second information indicating the number or percentage of occurrences of the second status. Alternatively, the terminal device 110 may determine whether the number or percentage of occurrences of the second status satisfies a fifth predetermined condition. The terminal device 110 may determine a fifth status that indicates the fifth predetermined condition is satisfied, if the number or percentage of occurrences of the second status satisfies the fifth predetermined condition. In this case, the second information transmitted from the terminal device 110 to the network device 120 may include the fifth status. In some embodiments, the number or percentage of occurrences of the second status may be larger than or equal to a thirteenth threshold. Alternatively, the number or percentage of occurrences of the second status is less than or equal to the thirteenth threshold.

Alternatively, the terminal device 110 may determine a statistical RSRP difference based on a plurality of monitored results of the data processing model. In this case, the terminal device 110 may transmit the second information to network device 120, which includes the statistical RSRP difference. The statistical RSRP difference may be one of the followings of the L1-RSRP difference: mean, variance, standard deviation, minimum, median, maximum, CDF-related quantity. By way of example, after completing N (N>1) times of model monitoring, the terminal device 110 can determine N monitored results. Specifically, for each model monitoring, the terminal device 110 needs to determine a L1-RSRP difference. The terminal device 110 may determines a statistical L1-RSRP difference based on the N monitored results (i.e., N L1-RSRP difference). For example, the statistical L1-RSRP difference can be a statistic (e.g., mean, variance, standard deviation, minimum, median, maximum, CDF-related quantity (e.g., L1-RSRP difference corresponding to 90%)) of the N L1-RSRP differences (e.g., L1-RSRP difference 1). In this case, the terminal device 110 may report the statistical L1-RSRP difference to the network device 120.

In some embodiments, the terminal device 110 may determine a number or percentage of occurrences of third status is based on a plurality of monitored results of the data processing model. For example, after completing N (N>1) times of model monitoring, the terminal device 110 can determine N monitored results. Specifically, for each model monitoring, the terminal device 110 needs to determine whether a third status occurs. In some embodiments, the second information transmitted from the terminal device 110 to the network device 120 may include the number or percentage of occurrences of third status. Alternatively, the terminal device 110 may determine whether the number or percentage of occurrences of third status satisfies a sixth predetermined condition. If the number or percentage of occurrences of third status satisfies a sixth predetermined condition, the terminal device 110 may determine a sixth status that indicates the sixth predetermined condition is satisfied. In this case, the terminal device 110 may transmit the second information that comprising the sixth status.

In some embodiments, the sixth predetermined condition may indicate the number or percentage of occurrences of the third status is larger than or equal to a fourteenth threshold. Alternatively, the sixth predetermined condition may indicate the number or percentage of occurrences of the third status is less than or equal to the fourteenth threshold.

In some embodiments, for each model monitoring, the terminal device 110 needs to determine whether a third status corresponding to a rank, layer or AI/ML model occurs. Accordingly, the terminal device 110 may determine at least one number or percentage of occurrences of the third status based on the N monitored results, and each number or percentage corresponds to a rank, layer or AI/ML model. Then, the terminal device 110 may report the at least one number or percentage. Optionally, the terminal device 110 can also determine and report at least one sixth state based on the at least one number or percentage, and each sixth status corresponds to a rank, layer or AI/ML model.

Alternatively, or in addition, the terminal device 110 may report the sixth status corresponding to all configured or indicated ranks, layers or AI/ML models. The mapping order of 1-bit fields indicating the sixth status in UCI or MAC-CE may be determined based on the indicators of the ranks, layers or AI/ML models corresponding to the sixth statuses.

In some embodiments, the terminal device 110 may determine at least one of: a statistical SGCS or a statistical NMSE based on a plurality of monitored results of the data processing model. In this case, the second information transmitted from the terminal device 110 to the network device 120 may include at least one of: the statistical SGCS or the statistical NMSE. By way of example, after completing N (N>1) times of model monitoring, the terminal device 110 can determine N monitored results. Specifically, for each model monitoring, the terminal device 110 can determine at least one SGCS or NMSE. Further, each SGCS may correspond to a rank, layer or AI/ML model. In some embodiments, the terminal device 110 determines at least one statistical SGCS or NMSE based on the N monitored results (i.e., the determined SGCSs or NMSEs). Further, each statistical SGCS may correspond to a rank, layer or AI/ML model. In this case, the terminal device 110 may report the at least one statistical SGCS or NMSE to NW. The statistical NMSE can be a statistic (e.g., mean, variance, standard deviation, minimum, median, maximum) of the N NMSEs.

In some embodiments, when a determined SGCS corresponds to a rank, layer or AI/ML model, the statistical SGCS (corresponding to/associated with the rank, layer or AI/ML model) can be a statistic of the SGCSs corresponding to the rank, layer or AI/ML model. Optionally, the statistical SGCS can be a statistic of the SGCSs corresponding to all (configured or indicated) ranks, layers or AI/ML models. Alternatively, when the terminal device 110 determines one SGCS (e.g., an average or weighted SGCS) during model monitoring, the statistical SGCS can be a statistic of the N SGCSs.

According to embodiments described with reference to FIG. 2, the terminal device or the network device knows how to report the performance (metric) of the AI/ML model. Further, based on the reported information related to the performance, the network device can make reasonable and systematic decisions related to the AI/ML model for UE, and provide reasonable configuration or indication information related to the AI/ML model for the terminal device.

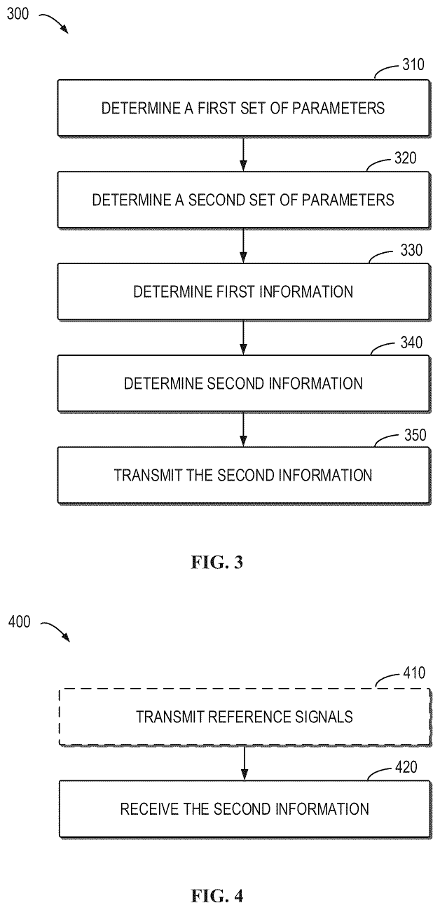

FIG. 3 illustrates a flowchart of a communication method 300 implemented at a terminal device in accordance with some embodiments of the present disclosure. In some embodiments, the method 300 may be implemented by the terminal device 110 in FIG. 1.

In some embodiments, the terminal device 110 may receive a first set of reference signals from the network device. The terminal device 110 may perform a first measurement on the first set of reference signals.

At block 310, the terminal device 110 determines, based on a first measurement on a first set of reference signals, a first set of parameters. For example, in some embodiments, the terminal device 110 may determine a first set of beams based on RSRPs of the first set of reference signals. In this case, the first set of parameters may include the first set of beams. Alternatively, the first set of parameters may include first channel state information.

At block 320, the terminal device 110 determines, based on a data processing model and a second measurement on a second set of reference signals, a second set of parameters. For example, in some embodiments, the terminal device 110 may determine a second set of beams based on RSRPs of the second set of reference signals. In this case, the second set of parameters may include the second set of beams. Alternatively, the second set of parameters may include second channel state information. For example, the measured L1-RSRPs of the beams in the second set of reference signals are used as the input (i.e., one input sample) of the data processing model. The beam IDs of the top-K beams out of the beams in the first set of reference signals may be the output of the data processing model.

At block 330, the terminal device 110 determines first information based on a comparison between the first set of parameters and the second set of parameters.

At block 340, the terminal device 110 determine second information based on predetermined condition information and the first information. The second information indicates at least one of: status information related to a performance metric, a number related to the performance metric, a percentage related to the performance metric, or the first information.

At block 350, the terminal device 110 transmits the second information to the network device. In some embodiments, the second information may be transmitted in uplink control information. Alternatively, or in addition, the second information may be in MAC CE.

In some embodiments, the first set of parameters comprises a first set of beams, and the second set of parameters comprises a second set of beams. In some embodiments, the predetermined condition information comprises a first predetermined condition.

In some embodiments, the terminal device 110 may determine, based on the comparison between the first set of beams and the second set of beams, the first information indicating whether the first set of beams overlaps with the second set of beams. In some embodiments, the terminal device 110 may determine whether the first information satisfies the first predetermined condition. In some embodiments, if the first information satisfies the first predetermined condition, the terminal device 110 may determine a first status that indicates the first predetermined condition is satisfied. In some embodiments, the terminal device 110 may transmit, to the network device, the second information comprising the first status.

In some embodiments, the first predetermined condition indicates at least one of: a first target beam in the first set of beams overlaps with the second set of beams, the first target beam in the first set of beams does not overlap with the second set of beams, a second target beam in the second set of beams overlaps with the first set of beams, or the second target beam in the second set of beams does not overlap with the first set of beams.

In some embodiments, the terminal device 110 may determine third information based on the first set of beams and the second set of beams. The third information may indicate which beam in the first set of beams overlaps with the first target beam in the second set of beams. In some embodiments, the terminal device 110 may transmit, to the network device, the second information comprising the first status, the third information and beam information of the first set of beams. In some embodiments, if the first status indicates the first target beam in the first set of beams does not overlap with the second set of beams, the third information is omitted.

In some embodiments, the first set of parameters comprises a first measured beam quality of a first beam in the first set of beams, and the second set of parameters comprises a second measured beam quality of a second beam in the second set of beams. In some embodiments, the first set of parameters comprises a first set of measured beam qualities of beams in the first set of beams, and the second set of parameters comprises a second set of predicted beam qualities of beams in the second set of beams. In some embodiments, the predetermined condition information comprises a second predetermined condition.

In some embodiments, the first beam refers to a beam with best beam quality in the first set of beams and the second beam refers to a beam with best beam quality in the second set of beams. In some embodiments, the first beam is same as the second beam.

In some embodiments, the terminal device 110 may determine, based on the comparison between the first measured beam quality and the second measured beam quality, the first information indicating a first difference between the first measured beam quality and the second measured beam quality. In some embodiments, the terminal device 110 may determine whether the first information satisfies the second predetermined condition. In some embodiments, if the first information satisfied the second predetermined condition, the terminal device 110 may determine a second status that indicates the second predetermined condition is satisfied. In some embodiments, the terminal device 110 may transmit, to the network device, the second information comprising the second status.

In some embodiments, the second predetermined condition indicates one of: the first difference is less than or equal to a first threshold, or the first difference is larger than or equal to the first threshold.

In some embodiments, the terminal device 110 may determine, based on the comparison between the first set of measured beam qualities and the second set of predicted beam qualities, the first information indicating a first set of differences between the first set of measured beam qualities and the second set of predicted beam qualities, or a statistic of the first set of differences. In some embodiments, the terminal device 110 may determine whether the first information satisfies the second predetermined condition. In some embodiments, if the first information satisfies the second predetermined condition, the terminal device 110 may determine a second status that indicates the second predetermined condition is satisfied. In some embodiments, the terminal device 110 may transmit, to the network device, the second information comprising the second status.

In some embodiments, the second predetermined condition indicates one of: the number of second differences in the first set of differences is less than or equal to a second threshold, or the number of second differences in the first set of differences is larger than or equal to the second threshold. The second difference may refer to a difference that is less than or equal to a threshold, or larger than or equal to a third threshold, a statistic of the first set of differences is less than or equal to a fourth threshold, or the statistic is larger than or equal to the fourth threshold. In some embodiments, the second information comprises the first status and the second status.

In some embodiments, the terminal device 110 may determine, based on the comparison between the first set of measured beam qualities and the second set of predicted beam qualities, the first information indicating a first set of differences between the first set of measured beam qualities and the second set of predicted beam qualities. In some embodiments, the terminal device 110 may determine a first number of differences based on the first set of differences and the second predetermined condition. In some embodiments, the terminal device 110 may transmit, to the network device, the second information comprising the first number of differences. In some embodiments, the second predetermined condition comprises one of: the difference is less than or equal to a fifth threshold, or the difference is larger than or equal to the fifth threshold.

In some embodiments, the first set of parameters comprises first channel state information, and the second set of parameters comprises second channel state information. In some embodiments, the predetermined condition information comprises a third predetermined condition.

In some embodiments, the terminal device 110 may determine, based on the comparison between the first channel state information and the second channel state information, the first information indicating a squared generalized cosine similarity (SGCS) or normalized mean squared error (NMSE). In some embodiments, the terminal device 110 may determine whether the first information satisfies the third predetermined condition. In some embodiments, if the first information satisfies the third predetermined condition, the terminal device 110 may determine a third status that indicates the third predetermined condition is satisfied. In some embodiments, the terminal device 110 may transmit, to the network device, the second information comprising the third status.

In some embodiments, the SGCS comprises one of: a SGCS associated with/corresponding to a rank, layer or data processing model, an averaged SGCS corresponding to the list of ranks, layers or data processing models, or a statistic of SGCSs corresponding to the list of ranks, layers or data processing models. In some embodiments, the NMSE comprises one of: a NMSE associated with or corresponding to the data processing model, or a statistic of NMSEs corresponding to the list of data processing models.

In some embodiments, the third predetermined condition indicates at least one of: a SGCS is larger than or equal to a sixth threshold, the SGCS is less than or equal to the sixth threshold, the NMSE is less than or equal to a ninth threshold, the NMSE is larger than or equal to the ninth threshold, the number of SGCSs that are larger than or equal to the sixth threshold is larger than or equal to a tenth threshold, the number of SGCSs that are larger than or equal to the sixth threshold is less than or equal to the tenth threshold, the number of NMSEs that are less than or equal to the seventh threshold is larger than or equal to an eleventh threshold, or the number of NMSEs that are less than or equal to the seventh threshold is less than or equal to the eleventh threshold.

In some embodiments, the terminal device 110 may determine, based on the comparison between the first channel state information and the second channel state information, SGCSs or NMSEs. In some embodiments, the terminal device 110 may determine a first set of SGCs or NMSEs based on the SGCSs or NMSEs and the predetermined condition. In some embodiments, the terminal device 110 may transmit, to the network device, the second information comprising at least one of: indicators of rank, layer or data processing model of the first set of SGCSs or NMSEs, or the first set of SGCSs or NMSEs. In some embodiments, the terminal device 110 may transmit, to the network device, the second information comprising at least one of: indicators of rank, layer or data processing model of the SGCSs or NMSEs, or the SGCSs or NMSEs.

In some embodiments, the third predetermined condition comprises at least one of: the first set of SGCSs comprises N1 SGCSs having largest values in the SGCSs, or the first set of NMSEs comprises N1 NMSEs having lowest values in the NMSEs, wherein N1 is an integer number.

In some embodiments, the terminal device 110 may determine a number or percentage of occurrences of the first status based on a plurality of monitored results of the data processing model. In some embodiments, the terminal device 110 may transmit, to the network device, the second information indicating the number or percentage of occurrences of the first status.

In some embodiments, the terminal device 110 may determine a number or percentage of occurrences of the first status based on a plurality of monitored results of the data processing model. In some embodiments, the terminal device 110 may determine whether the number or percentage of occurrences of the first status satisfies a fourth predetermined condition. In some embodiments, the terminal device 110 may in accordance with a determination that the number or percentage of occurrences of the first status satisfies a fourth predetermined condition, determine a fourth status that indicates the fourth predetermined condition is satisfied. In some embodiments, the terminal device 110 may transmit, to the network device, the second information comprising the fourth status.

In some embodiments, the fourth predetermined condition indicates one of: the number or percentage of occurrences of the first status is larger than or equal to a twelfth threshold, or the number or percentage of occurrences of the first status is less than or equal to the twelfth threshold.

In some embodiments, the terminal device 110 may determine a number or percentage of occurrences of the second status based on a plurality of monitored results of the data processing model. In some embodiments, the terminal device 110 may transmit, to the network device, the second information indicating the number or percentage of occurrences of the second status.

In some embodiments, the terminal device 110 may determine a number or percentage of occurrences of the second status based on a plurality of monitored results of the data processing model. In some embodiments, the terminal device 110 may determine whether the number or percentage of occurrences of the second status satisfies a fifth predetermined condition. In some embodiments, if the number or percentage of occurrences of the second status satisfies the fifth predetermined condition, the terminal device 110 may determine a fifth status that indicates the fifth predetermined condition is satisfied. In some embodiments, the terminal device 110 may transmit, to the network device, the second information comprising the fifth status.

In some embodiments, the fifth predetermined condition indicates one of: the number or percentage of occurrences of the second status is larger than or equal to a thirteenth threshold, or the number or percentage of occurrences of the second status is less than or equal to the thirteenth threshold.

In some embodiments, the terminal device 110 may determine a statistical RSRP difference based on a plurality of monitored results of the data processing model. In some embodiments, the terminal device 110 may transmit, to the network device, the second information indicating the statistical RSRP difference.

In some embodiments, the terminal device 110 may determine a number or percentage of occurrences of third status is based on a plurality of monitored results of the data processing model. In some embodiments, the terminal device 110 may transmit, to the network device, the second information indicating the number or percentage of occurrences of third status.

In some embodiments, the terminal device 110 may determine a number or percentage of occurrences of third status is based on a plurality of monitored results of the data processing model. In some embodiments, the terminal device 110 may determine whether the number or percentage of occurrences of third status satisfies a sixth predetermined condition. In some embodiments, if the number or percentage of occurrences of third status satisfies a sixth predetermined condition, the terminal device 110 may determine a sixth status that indicates the sixth predetermined condition is satisfied. In some embodiments, the terminal device 110 may transmit, to the network device, the second information comprising the sixth status.

In some embodiments, the sixth predetermined condition indicates the number or percentage of occurrences of the third status is larger than or equal to a fourteenth threshold. In some embodiments, the sixth predetermined condition indicates the number or percentage of occurrences of the third status is less than or equal to the fourteenth threshold.

In some embodiments, the terminal device 110 may determine at least one of: a statistical SGCS or a statistical NMSE based on a plurality of monitored results of the data processing model. In some embodiments, the terminal device 110 may transmit, to the network device, the second information indicating the at least one of: the statistical SGCS or the statistical NMSE.

In some embodiments, the second information is transmitted in a CSI report. In some embodiments, the second information is transmitted in a medium access control control element (MAC CE). In some embodiments, if the second information comprises the third information, the terminal device 110 may determine a bitwidth for the third information based on the number of beams to be reported.

In some embodiments, the terminal device 110 may determine a bitwidth for the first number of differences based on the number of the first set of beams or reference signals. In some embodiments, the terminal device 110 may transmit, to the network device, the first number of differences in a first part of a CSI report, and the values of the differences in a second part of the CSI report. In some embodiments, the terminal device 110 may determine a bitwidth for the number or percentage of occurrences of the first, second or third status based on the number of times of model monitoring.

FIG. 4 illustrates a flowchart of a communication method 400 implemented at a network device in accordance with some embodiments of the present disclosure. In some embodiments, the method 400 may be implemented by the network device 120 in FIG. 1.

The network device 120 may transmit a configuration to the terminal device 110. The configuration may indicate a first set of reference signals and/or resources of the first set of reference signals. In addition, the configuration may indicate a second set of reference signals and/or resources of the second set of reference signals. In some embodiments, the second set of reference signals may be a subset of the first set of reference signals. Alternatively, the second set of reference signals may be same as the first set of reference signals. In some other embodiments, the second set of reference signals may be different from the first set of reference signals. In some embodiments, the first set of reference signals and the second set of reference signals may refer to CSI-RSs. Alternatively, the first set of reference signals and the second set of reference signals may refer to SSBs. It is noted that the first set of reference signals and the second set of reference signals may refer to any proper types of reference signals.

In addition, the configuration may indicate a data processing model for monitoring. For example, the configuration may comprise an index of the data processing model. Alternatively, the configuration may comprise model parameters for the data processing model. The data processing model can be represented or indicated by (or replaced with) a model ID or functionality. For the case of CSI compression, the AI/ML model may be equivalent to CSI generation part or CSI reconstruction part.

At block 410, the network device 120 may transmit a plurality of reference signals to the terminal device 110. For example, the plurality of reference signals includes the first set of reference signals and the second set of reference signals. In some embodiments, the plurality of reference signals may be a plurality of CSI-RSs. Alternatively, or in addition, the plurality of reference signals may be a plurality of SSBs.

At block 420, the network device 120 receives, from the terminal device 110, second information indicating indicates at least one of: status information related to a performance metric, a number related to the performance metric, or a percentage related to the performance metric. The second information is determined based on predetermined condition information and first information. The first information is determined based on a comparison between a first set of parameters and a second set of parameters. The the first set of parameters is determined based on a first measurement on a first set of reference signals, and the second set of parameters is determined based on and a second measurement on a second set of reference signals.

In some embodiments, the first set of parameters comprises a first set of beams, and the second set of parameters comprises a second set of beams. In some embodiments, the predetermined condition information comprises a first predetermined condition.

In some embodiments, the second information may include a first status that indicates the first predetermined condition is satisfied. In some embodiments, the first predetermined condition indicates at least one of: a first target beam in the first set of beams overlaps with the second set of beams, the first target beam in the first set of beams does not overlap with the second set of beams, a second target beam in the second set of beams overlaps with the first set of beams, or the second target beam in the second set of beams does not overlap with the first set of beams.

In some embodiments, the second information may include the first status, the third information and beam information of the first set of beams. The third information may indicate which beam in the first set of beams overlaps with the first target beam in the second set of beams.

In some embodiments, if the first status indicates the first target beam in the first set of beams does not overlap with the second set of beams, the third information is omitted.

In some embodiments, the first set of parameters comprises a first measured beam quality of a first beam in the first set of beams, and the second set of parameters comprises a second measured beam quality of a second beam in the second set of beams. In some embodiments, the first set of parameters comprises a first set of measured beam qualities of beams in the first set of beams, and the second set of parameters comprises a second set of predicted beam qualities of beams in the second set of beams. In some embodiments, the predetermined condition information comprises a second predetermined condition.

In some embodiments, the first beam refers to a beam with best beam quality in the first set of beams and the second beam refers to a beam with the best beam quality in the second set of beams. In some embodiments, the first beam is same as the second beam.

In some embodiments, the second information comprises a second status that indicates the second predetermined condition is satisfied.

In some embodiments, the second predetermined condition indicates one of: the first difference is less than or equal to a first threshold, or the first difference is larger than or equal to the first threshold.

In some embodiments, the second information comprises a second status that indicates the second predetermined condition is satisfied.

In some embodiments, the second predetermined condition indicates one of: the number of second differences in the first set of differences is less than or equal to a second threshold, or the number of second differences in the first set of differences is larger than or equal to the second threshold. The second difference may refer to a difference that is less than or equal to a threshold, or larger than or equal to a third threshold, a statistic of the first set of differences is less than or equal to a fourth threshold, or the statistic is larger than or equal to the fourth threshold. In some embodiments, the second information comprises the first status and the second status.

In some embodiments, the second information comprising a first set of differences between the first set of measured beam qualities and the second set of predicted beam qualities. In some embodiments, the second predetermined condition comprises one of: the difference is less than or equal to a fifth threshold, or the difference is larger than or equal to the fifth threshold.

In some embodiments, the first set of parameters comprises first channel state information, and the second set of parameters comprises second channel state information. In some embodiments, the predetermined condition information comprises a third predetermined condition.

In some embodiments, the second information comprises a third status that indicates the third predetermined condition is satisfied. In some embodiments, the SGCS comprises one of: a SGCS associated with or corresponding to a rank, layer or data processing model, an averaged SGCS corresponding to the list of ranks, layers or data processing models, or a statistic of SGCSs corresponding to the list of ranks, layers or data processing models. In some embodiments, the NMSE comprises one of: a NMSE associated with or corresponding to a data processing model, or a statistic of NMSEs corresponding to the list of data processing models.

In some embodiments, the third predetermined condition indicates at least one of: a SGCS is larger than or equal to a sixth threshold, the SGCS is less than or equal to the sixth threshold, the NMSE is less than or equal to a ninth threshold, the NMSE is larger than or equal to the ninth threshold, the number of SGCSs that are larger than or equal to the sixth threshold is larger than or equal to a tenth threshold, the number of SGCSs that are larger than or equal to the sixth threshold is less than or equal to the tenth threshold, the number of NMSEs that are less than or equal to the seventh threshold is larger than or equal to an eleventh threshold, or the number of NMSEs that are less than or equal to the seventh threshold is less than or equal to the eleventh threshold.

In some embodiments, the second information comprises at least one of: indicators of rank, layer or data processing model of the first set of SGCSs or NMSEs, or the first set of SGCSs or NMSEs. In some embodiments, the second information comprises at least one of: indicators of rank, layer or data processing model of the SGCSs or NMSEs, or the SGCSs or NMSEs.

In some embodiments, the third predetermined condition comprises at least one of: the first set of SGCSs comprises N1 SGCSs having largest values in the SGCSs, or the first set of NMSEs comprises N1 NMSEs having lowest values in the NMSEs, wherein N1 is an integer number.

In some embodiments, the second information indicates the number or percentage of occurrences of the first status.

In some embodiments, the second information comprises a fourth status that indicates the fourth predetermined condition is satisfied.

In some embodiments, the fourth predetermined condition indicates one of: the number or percentage of occurrences of the first status is larger than or equal to a twelfth threshold, or the number or percentage of occurrences of the first status is less than or equal to the twelfth threshold.

In some embodiments, the second information indicates the number or percentage of occurrences of the second status.

In some embodiments, the second information comprises a fifth status that indicates the fifth predetermined condition is satisfied.

In some embodiments, the fifth predetermined condition indicates one of: the number or percentage of occurrences of the second status is larger than or equal to a thirteenth threshold, or the number or percentage of occurrences of the second status is less than or equal to the thirteenth threshold.

In some embodiments, the second information indicates a statistical RSRP difference.

In some embodiments, the second information indicates the number or percentage of occurrences of third status.

In some embodiments, the second information comprises a sixth status that indicates the sixth predetermined condition is satisfied.

In some embodiments, the sixth predetermined condition indicates the number or percentage of occurrences of the third status is larger than or equal to a fourteenth threshold. In some embodiments, the sixth predetermined condition indicates the number or percentage of occurrences of the third status is less than or equal to the fourteenth threshold.

In some embodiments, the second information indicates the at least one of: the statistical SGCS or the statistical NMSE.

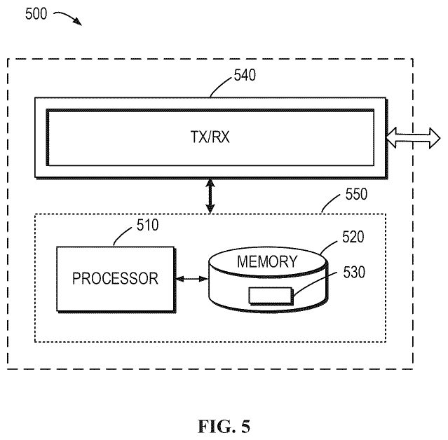

FIG. 5 is a simplified block diagram of a device 500 that is suitable for implementing embodiments of the present disclosure. The device 500 can be considered as a further example implementation of any of the devices as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX)/receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises a circuitry configured to: determine, based on a first measurement on a first set of reference signals, a first set of parameters; determine, based on a data processing model and a second measurement on a second set of reference signals, a second set of parameters; determine first information based on a comparison between the first set of parameters and the second set of parameters; determine second information based on predetermined condition information and the first information, wherein the second information indicates at least one of: status information related to a performance metric, a number related to the performance metric, a percentage related to the performance metric, or the first information; and transmit the second information to the network device.

In some embodiments, a network device comprises a circuitry configured to: receive, from a terminal device, second information indicating indicates at least one of: status information related to a performance metric, a number related to the performance metric, a percentage related to the performance metric, or the first information, wherein the second information is determined based on predetermined condition information and first information, wherein the first information is determined based on a comparison between a first set of parameters and a second set of parameters, and wherein the first set of parameters is determined based on a first measurement on a first set of reference signals, and the second set of parameters is determined based on and a second measurement on a second set of reference signals.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a terminal device for communication, comprises a processor, configured to cause the terminal device to: determine, based on a first measurement on a first set of reference signals, a first set of parameters; determine, based on a data processing model and a second measurement on a second set of reference signals, a second set of parameters; determine first information based on a comparison between the first set of parameters and the second set of parameters; determine second information based on predetermined condition information and the first information, wherein the second information indicates at least one of: status information related to a performance metric, a number related to the performance metric, a percentage related to the performance metric, or the first information; and transmit the second information to the network device.

In some aspects, the first set of parameters comprises a first set of beams, and the second set of parameters comprises a second set of beams, and the predetermined condition information comprises a first predetermined condition.

In some aspects, the processor is configured to further cause the terminal device to: determine, based on the comparison between the first set of beams and the second set of beams, the first information indicating whether the first set of beams overlaps with the second set of beams; determine whether the first information satisfies the first predetermined condition; in accordance with a determination that the first information satisfies the first predetermined condition, determine a first status that indicates the first predetermined condition is satisfied; and transmit, to the network device, the second information comprising the first status.

In some aspects, the first predetermined condition indicates at least one of: a first target beam in the first set of beams overlaps with the second set of beams, the first target beam in the first set of beams does not overlap with the second set of beams, a second target beam in the second set of beams overlaps with the first set of beams, or the second target beam in the second set of beams does not overlap with the first set of beams.

In some aspects, the processor is configured to further cause the terminal device to: determine third information based on the first set of beams and the second set of beams, where the third information indicates which beam in the first set of beams overlaps with the first target beam in the second set of beams; transmit, to the network device, the second information comprising the first status, the third information and beam information of the first set of beams.

In some aspects, in accordance with a determination that the first status indicates the first target beam in the first set of beams does not overlap with the second set of beams, the third information is omitted.

In some aspects, the first set of parameters comprises a first measured beam quality of a first beam in the first set of beams, and the second set of parameters comprises a second measured beam quality of a second beam in the second set of beams, or wherein the first set of parameters comprises a first set of measured beam qualities of beams in the first set of beams, and the second set of parameters comprises a second set of predicted beam qualities of beams in the second set of beams; and wherein the predetermined condition information comprises a second predetermined condition.

In some aspects, the first beam refers to a beam with best quality in the first set of beams and the second beam refers to a beam with the best quality in the second set of beams, or wherein the first beam is same as the second beam.

In some aspects, the processor is configured to further cause the terminal device to: determine, based on the comparison between the first measured beam quality and the second measured beam quality, the first information indicating a first difference between the first measured beam quality and the second measured beam quality; determine whether the first information satisfies the second predetermined condition; in accordance with a determination that the first information satisfied the second predetermined condition, determine a second status that indicates the second predetermined condition is satisfied; and transmit, to the network device, the second information comprising the second status.

In some aspects, the second predetermined condition indicates one of: the first difference is less than or equal to a first threshold, or the first difference is larger than or equal to the first threshold.

In some aspects, the processor is configured to further cause the terminal device to: determine, based on the comparison between the first set of measured beam qualities and the second set of predicted beam qualities, the first information indicating a first set of differences between the first set of measured beam qualities and the second set of predicted beam qualities, or a statistic of the first set of differences; determine whether the first information satisfies the second predetermined condition; in accordance with a determination that the first information satisfies the second predetermined condition, determine a second status that indicates the second predetermined condition is satisfied; and transmit, to the network device, the second information comprising the second status.

In some aspects, the second predetermined condition indicates one of: the number of second differences in the first set of differences is less than or equal to a second threshold, or the number of second differences in the first set of differences is larger than or equal to the second threshold, and wherein the second difference refers to a difference that is less than or equal to a threshold, or larger than or equal to a third threshold, a statistic of the first set of differences is less than or equal to a fourth threshold, or the statistic is larger than or equal to the fourth threshold.

In some aspects, the second information comprises the first status and the second status.

In some aspects, the processor is configured to further cause the terminal device to: determine, based on the comparison between the first set of measured beam qualities and the second set of predicted beam qualities, the first information indicating a first set of differences between the first set of measured beam qualities and the second set of predicted beam qualities; determine a first number of differences based on the first set of differences and the second predetermined condition; and transmit, to the network device, the second information comprising the first number of differences.

In some aspects, the second predetermined condition comprises one of: the difference is less than or equal to a fifth threshold, or the difference is larger than or equal to the fifth threshold.

In some aspects, the first set of parameters comprises first channel state information, and the second set of parameters comprises second channel state information, and wherein the predetermined condition information comprises a third predetermined condition.

In some aspects, the processor is configured to further cause the terminal device to: determine, based on the comparison between the first channel state information and the second channel state information, the first information indicating a squared generalized cosine similarity (SGCS) or normalized mean squared error (NMSE); determine whether the first information satisfies the third predetermined condition; in accordance with a determination that the first information satisfies the third predetermined condition, determine a third status that indicates the third predetermined condition is satisfied; and transmit, to the network device, the second information comprising the third status.

In some aspects, the SGCS comprises one of: a SGCS associated with or corresponding to a rank, layer or data processing model, an averaged SGCS corresponding to the list of ranks, layers or data processing models, or a statistic of SGCSs corresponding to the list of ranks, layers or data processing models; and wherein the NMSE comprises one of: a NMSE associated with or corresponding to a data processing model, or a statistic of NMSEs corresponding to the list of data processing models.

In some aspects, the third predetermined condition indicates at least one of: a SGCS is larger than or equal to a sixth threshold, the SGCS is less than or equal to the sixth threshold, the NMSE is less than or equal to a ninth threshold, the NMSE is larger than or equal to the ninth threshold, the number of SGCSs that are larger than or equal to the sixth threshold is larger than or equal to a tenth threshold, the number of SGCSs that are larger than or equal to the sixth threshold is less than or equal to the tenth threshold, the number of NMSEs that are less than or equal to the seventh threshold is larger than or equal to an eleventh threshold, or the number of NMSEs that are less than or equal to the seventh threshold is less than or equal to the eleventh threshold.

In some aspects, the processor is configured to further cause the terminal device to: determine, based on the comparison between the first channel state information and the second channel state information, SGCSs or NMSEs; determine a first set of SGCs or NMSEs based on the SGCSs or NMSEs and the predetermined condition; and transmit, to the network device, the second information comprising at least one of: indicators of rank, layer or data processing model of the first set of SGCSs or NMSEs, or the first set of SGCSs or NMSEs; or transmit, to the network device, the second information comprising at least one of: indicators of rank, layer or data processing model of the SGCSs or NMSEs, or the SGCSs or NMSEs.

In some aspects, the third predetermined condition comprises at least one of: the first set of SGCSs comprises N1 SGCSs having largest values in the SGCSs, or the first set of NMSEs comprises N1 NMSEs having lowest values in the NMSEs, wherein N1 is an integer number.

In some aspects, the processor is configured to further cause the terminal device: determine a number or percentage of occurrences of the first status based on a plurality of monitored results of the data processing model; and transmit, to the network device, the second information indicating the number or percentage of occurrences of the first status.

In some aspects, the processor is configured to further cause the terminal device: determine a number or percentage of occurrences of the first status based on a plurality of monitored results of the data processing model; determine whether the number or percentage of occurrences of the first status satisfies a fourth predetermined condition; in accordance with a determination that the number or percentage of occurrences of the first status satisfies a fourth predetermined condition, determine a fourth status that indicates the fourth predetermined condition is satisfied; and transmit, to the network device, the second information comprising the fourth status.

In some aspects, the fourth predetermined condition indicates one of: the number or percentage of occurrences of the first status is larger than or equal to a twelfth threshold, or the number or percentage of occurrences of the first status is less than or equal to the twelfth threshold.

In some aspects, the processor is configured to further cause the terminal device to: determine a number or percentage of occurrences of the second status based on a plurality of monitored results of the data processing model; and transmit, to the network device, the second information indicating the number or percentage of occurrences of the second status.

In some aspects, the processor is configured to further cause the terminal device to: determine a number or percentage of occurrences of the second status based on a plurality of monitored results of the data processing model; determine whether the number or percentage of occurrences of the second status satisfies a fifth predetermined condition; in accordance with a determination that the number or percentage of occurrences of the second status satisfies the fifth predetermined condition, determine a fifth status that indicates the fifth predetermined condition is satisfied; and transmit, to the network device, the second information comprising the fifth status.

In some aspects, the fifth predetermined condition indicates one of: the number or percentage of occurrences of the second status is larger than or equal to a thirteenth threshold, or the number or percentage of occurrences of the second status is less than or equal to the thirteenth threshold.

In some aspects, the processor is configured to further cause the terminal device to: determine a statistical RSRP difference based on a plurality of monitored results of the data processing model; and transmit, to the network device, the second information indicating the statistical RSRP difference.

In some aspects, the processor is configured to further cause the terminal device to: determine a number or percentage of occurrences of third status is based on a plurality of monitored results of the data processing model; and transmit, to the network device, the second information indicating the number or percentage of occurrences of third status.

In some aspects, the processor is configured to further cause the terminal device to: determine a number or percentage of occurrences of third status is based on a plurality of monitored results of the data processing model; determine whether the number or percentage of occurrences of third status satisfies a sixth predetermined condition; in accordance with a determination that the number or percentage of occurrences of third status satisfies a sixth predetermined condition, determine a sixth status that indicates the sixth predetermined condition is satisfied; and transmit, to the network device, the second information comprising the sixth status.

In some aspects, the sixth predetermined condition indicates one of: the number or percentage of occurrences of the third status is larger than or equal to a fourteenth threshold, or the number or percentage of occurrences of the third status is less than or equal to the fourteenth threshold.

In some aspects, the processor is configured to further cause the terminal device to: determine at least one of: a statistical SGCS or a statistical NMSE based on a plurality of monitored results of the data processing model; and transmit, to the network device, the second information indicating the at least one of: the statistical SGCS or the statistical NMSE.

In some aspects, the second information is transmitted in a CSI report, or wherein the second information is transmitted in a medium access control control element (MAC CE).

In some aspects, the processor is configured to further cause the terminal device to: in accordance with a determination that the second information comprises the third information, determine a bitwidth for the third information based on the number of beams to be reported.

In some aspects, the processor is configured to further cause the terminal device to: determine a bitwidth for the first number of differences based on the number of the first set of beams or reference signals.

In some aspects, the processor is configured to further cause the terminal device to transmit, to the network device, the first number of differences in a first part of a CSI report, and the values of the differences in a second part of the CSI report.

In some aspects, the processor is configured to further cause the terminal device to: determine a bitwidth for the number or percentage of occurrences of the first, second or third status based on the number of times of model monitoring.

In an aspect, a network device for communication, comprises a processor, configured to cause the network device to: receive, from a terminal device, second information indicating indicates at least one of: status information related to a performance metric, a number related to the performance metric, a percentage related to the performance metric, or the first information, wherein the second information is determined based on predetermined condition information and first information, wherein the first information is determined based on a comparison between a first set of parameters and a second set of parameters, and wherein the first set of parameters is determined based on a first measurement on a first set of reference signals, and the second set of parameters is determined based on and a second measurement on a second set of reference signals.

In some aspects, the first set of parameters comprises a first set of beams, and the second set of parameters comprises a second set of beams. In some embodiments, the predetermined condition information comprises a first predetermined condition.

In some aspects, the second information may include a first status that indicates the first predetermined condition is satisfied. In some embodiments, the first predetermined condition indicates at least one of: a first target beam in the first set of beams overlaps with the second set of beams, the first target beam in the first set of beams does not overlap with the second set of beams, a second target beam in the second set of beams overlaps with the first set of beams, or the second target beam in the second set of beams does not overlap with the first set of beams.

In some aspects, the second information may include the first status, the third information and beam information of the first set of beams. The third information may indicate which beam in the first set of beams overlaps with the first target beam in the second set of beams.

In some aspects, if the first status indicates the first target beam in the first set of beams does not overlap with the second set of beams, the third information is omitted.

In some aspects, the first set of parameters comprises a first measured beam quality of a first beam in the first set of beams, and the second set of parameters comprises a second measured beam quality of a second beam in the second set of beams. In some embodiments, the first set of parameters comprises a first set of measured beam qualities of beams in the first set of beams, and the second set of parameters comprises a second set of predicted beam qualities of beams in the second set of beams. In some embodiments, the predetermined condition information comprises a second predetermined condition.

In some aspects, the first beam refers to a first target beam in the first set of beams and the second beam refers to the first target beam in the second set of beams. In some embodiments, the first beam is same as the second beam.

In some aspects, the second information comprises a second status that indicates the second predetermined condition is satisfied.

In some aspects, the second predetermined condition indicates one of: the first difference is less than or equal to a first threshold, or the first difference is larger than or equal to the first threshold.

In some aspects, the second information comprises a second status that indicates the second predetermined condition is satisfied.

In some aspects, the second predetermined condition indicates one of: the number of second differences in the first set of differences is less than or equal to a second threshold, or the number of second differences in the first set of differences is larger than or equal to the second threshold. The second difference may refer to a difference that is less than or equal to a threshold, or larger than or equal to a third threshold, a statistic of the first set of differences is less than or equal to a fourth threshold, or the statistic is larger than or equal to the fourth threshold. In some embodiments, the second information comprises the first status and the second status.

In some aspects, the second information comprising a first set of differences between the first set of measured beam qualities and the second set of predicted beam qualities. In some embodiments, the second predetermined condition comprises one of: the difference is less than or equal to a fifth threshold, or the difference is larger than or equal to the fifth threshold.

In some aspects, the first set of parameters comprises first channel state information, and the second set of parameters comprises second channel state information. In some embodiments, the predetermined condition information comprises a third predetermined condition.

In some aspects, the second information comprises a third status that indicates the third predetermined condition is satisfied. In some embodiments, the SGCS comprises one of: a SGCS associated with or corresponding to a rank, layer or data processing model, an averaged SGCS corresponding to the list of ranks, layers or data processing models, or a statistic of SGCSs corresponding to the list of ranks, layers or data processing models. In some embodiments, the NMSE comprises one of: a NMSE associated with or corresponding to a data processing model, or a statistic of NMSEs corresponding to the list of data processing models.

In some aspects, the third predetermined condition indicates at least one of: a SGCS is larger than or equal to a sixth threshold, the SGCS is less than or equal to the sixth threshold, the NMSE is less than or equal to a ninth threshold, the NMSE is larger than or equal to the ninth threshold, the number of SGCSs that are larger than or equal to the sixth threshold is larger than or equal to a tenth threshold, the number of SGCSs that are larger than or equal to the sixth threshold is less than or equal to the tenth threshold, the number of NMSEs that are less than or equal to the seventh threshold is larger than or equal to an eleventh threshold, or the number of NMSEs that are less than or equal to the seventh threshold is less than or equal to the eleventh threshold.

In some aspects, the second information comprises at least one of: indicators of rank, layer or data processing model of the first set of SGCSs or NMSEs, or the first set of SGCSs or NMSEs. In some embodiments, the second information comprises at least one of: indicators of rank, layer or data processing model of the SGCSs or NMSEs, or the SGCSs or NMSEs.

In some aspects, the third predetermined condition comprises at least one of the first set of SGCSs comprises N1 SGCSs having largest values in the SGCSs, or the first set of NMSEs comprises N1 NMSEs having lowest values in the NMSEs, wherein N1 is an integer number.

In some aspects, the second information indicates the number or percentage of occurrences of the first status.

In some aspects, the second information comprises a fourth status that indicates the fourth predetermined condition is satisfied.

In some aspects, the fourth predetermined condition indicates one of: the number or percentage of occurrences of the first status is larger than or equal to a twelfth threshold, or the number or percentage of occurrences of the first status is less than or equal to the twelfth threshold.

In some aspects, the second information indicates the number or percentage of occurrences of the second status.

In some embodiments, the second information comprises a fifth status that indicates the fifth predetermined condition is satisfied.

In some aspects, the fifth predetermined condition indicates one of: the number or percentage of occurrences of the second status is larger than or equal to a thirteenth threshold, or the number or percentage of occurrences of the second status is less than or equal to the thirteenth threshold.

In some aspects, the second information indicates a statistical RSRP difference.

In some aspects, the second information indicates the number or percentage of occurrences of third status.

In some aspects, the second information comprises a sixth status that indicates the sixth predetermined condition is satisfied.

In some aspects, the sixth predetermined condition indicates the number or percentage of occurrences of the third status is larger than or equal to a fourteenth threshold. In some embodiments, the sixth predetermined condition indicates the number or percentage of occurrences of the third status is less than or equal to the fourteenth threshold.

In some aspects, the second information indicates the at least one of: the statistical SGCS or the statistical NMSE.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, comprising:
determining, based on a first measurement on a first set of reference signals, a first set of beam parameters;
checking whether a condition that one of the first set of beam parameters mapped to one of a second set of predicted beam parameters is met;
determining first information that indicates a number of times the condition is met; and
transmitting the first information to a network device.

22. The method according to claim 21, wherein a bitwidth of a CSI field for indicating the first information is determined based on ┌log 2 (N+1)┐, wherein the N refers to a number of times of model monitoring.

23. The method according to claim 21, wherein the first information indicates an accuracy of a prediction of beams.

24. The method according to claim 23, wherein
the first set of beam parameters indicates a first set of beams,
the second set of predicted beam parameters indicates a second set of predicted beams, and
wherein the method further comprises:
determining third information based on the first set of beams and the second set of predicted beams, wherein the third information indicates which beam in the first set of beams overlaps with the first target beam in the second set of predicted beams; and
transmitting, to the network device, the third information.

25. The method according to claim 21, wherein the first set of beam parameters comprises a first measured beam quality of a first beam in a first set of beams, and the second set of predicted beam parameters comprises a second measured beam quality of a second beam in a second set of predicted beams, or
wherein the first set of beam parameters comprises a first set of measured beam qualities of beams in the first set of beams, and the second set of predicted beam parameters comprises a second set of predicted beam qualities of beams in the second set of predicted beams.

26. The method according to claim 25, wherein the first beam refers to a beam with best beam quality in the first set of beams and the second beam refers to a beam with best beam quality in the second set of predicted beams, or
wherein the first beam is the same as the second beam, or
wherein the first set of beams is the same as the second set of predicted beams.

27. The method according to claim 25, further comprising:
determining, based on a comparison between the first measured beam quality and the second measured beam quality, second information indicating a first difference between the first measured beam quality and the second measured beam quality; and
determining whether the second information satisfies a second condition, and wherein the second condition indicates one of: the first difference is less than or equal to a first threshold, or the first difference is larger than or equal to the first threshold;
wherein the first information also indicates whether the second information satisfies the second condition.

28. The method according to claim 25, further comprising:
determining, based on a comparison between the first set of measured beam qualities and the second set of predicted beam qualities, second information indicating a first set of differences between the first set of measured beam qualities and the second set of predicted beam qualities, or a statistic of the first set of differences; and
determining whether the second information satisfies second condition, and wherein the second condition indicates one of: the number of second differences in the first set of difference is less than or equal to a second threshold, the number of second differences in the first set of difference is larger than or equal to the second threshold, and wherein the second difference refers to a difference that is less than or equal to a threshold, or larger than or equal to a third threshold, the statistic is less than or equal to a fourth threshold, or the statistic is larger than or equal to the fourth threshold;
wherein the first information also indicates whether the second information satisfies the second condition.

29. The method according to claim 25, further comprising:
determining, based on a comparison between the first set of measured beam qualities and the second set of predicted beam qualities, a second information indicating a first set of differences between the first set of measured beam qualities and the second set of predicted beam qualities; and
determining at least one of a first number of differences or a second set of differences based on the first set of differences and a second condition, wherein the second condition comprises one of: the difference is less than or equal to a fifth threshold, or the difference is larger than or equal to the fifth threshold;
wherein the first information also comprises at least one of the first number of differences, or the second set of differences, and wherein the second set of differences comprises a subset of differences from the first set of differences which satisfies the second condition.

30. The method according to claim 21, wherein the first set of parameters comprises first channel state information, and the second set of parameters comprises second channel state information.

31. The method according to claim 21, further comprising:
determining a number or percentage of occurrences that met the first condition based on a plurality of monitored results of a data processing model; and
transmitting, to the network device, the first information indicating the number or percentage of occurrences.

32. The method according to claim 21, wherein the second information is transmitted in a CSI report, or
wherein the second information is transmitted in a medium access control control element (MAC CE).

33. The method according to claim 21, further comprising:
transmitting, to the network device, the first number of differences in a first part of a CSI report, and the second set of differences in a second part of the CSI report.

34. A terminal device, comprising:
at least one memory storing instructions, and
at least one processor configured to execute the instructions to:
determine, based on a first measurement on a first set of reference signals, a first set of beam parameters;
check whether a condition that one of the first set of beam parameters mapped to one of a second set of predicted beam parameters is met;
determine a first information that indicates a number of times the condition is met; and
transmit the first information to a network device.

35. The terminal device according to claim 34, wherein a bitwidth of a CSI field for indicating the first information is determined based on ┌log 2 (N+1)┐, wherein the N refers to a number of times of model monitoring.

36. The terminal device according to claim 34, wherein the first information indicates the accuracy of a prediction of beams.
